(19) United States
(12) Patent Application Publication
(10) Pub. No.: US 2026/0283120 A1
(43) Pub. Date: Sep. 24, 2026

(54) HEALTH-MONITORING FEEDER

(71) Applicant: Sean Steven FINTEL, Firth, NE (US)

(72) Inventor: Sean Steven FINTEL, Firth, NE (US)

(21) Appl. No.: 19/689,692

(22) Filed: May 27, 2026

Related U.S. Application Data
(63) Continuation-in-part of application No. 19/264,021, filed on Jul. 9, 2025.
(60) Provisional application No. 63/671,391, filed on Jul. 15, 2024.
(60) Provisional application No. 63/814,272, filed on May 29, 2025.
(60) Provisional application No. 63/869,015, filed on Aug. 22, 2025.

(51) Int. Cl. A01K 29/00; A01K 5/02; G06T 7/00; G06V 10/70; G06V 40/10; H04N 7/18; H04N 23/20; H04N 23/90

(52) U.S. Cl. CPC A01K 29/005; A01K 5/02; G06T 7/0012; G06V 10/70; G06V 40/10; H04N 7/181; H04N 23/20; H04N 23/90; G06T 2207/10048; G06T 2207/20081

(57) ABSTRACT

A proactive health monitoring system for a livestock animal uses imaging devices to capture images of the livestock animal during feeding and employs a communication module to transmit images, and feeding data embodied in the images, to a remote server. The remote server includes an artificial intelligence module trained to analyze the images for health indicators such as posture, gait, and physical features, a data processing module to generate health alerts and compile feeding summaries, and a notification module to transmit the alerts and summaries to a designated application or user device.

### CROSS-REFERENCE TO RELATED APPLICATIONS

This application claims priority to and benefit of co-pending U.S. Provisional Patent Application No. 63/869,015 filed on Aug. 22, 2025, entitled “RESOURCE ZONE EQUINE HEALTH MONITORING” by Sean Steven Fintel, having Attorney Docket No. EZGRAZER-003-PR, the disclosure of which is hereby incorporated herein by reference in its entirety.

This application claims priority to and benefit of co-pending U.S. Provisional Patent Application No. 63/814,272 filed on May 29, 2025, entitled “HEALTH-MONITORING FEEDER” by Sean Steven Fintel, having Attorney Docket No. EZGRAZER-002-PR, the disclosure of which is hereby incorporated herein by reference in its entirety.

This application is a continuation-in-part of and claims priority to and benefit of co-pending U.S. patent application Ser. No. 19/264,021 filed on Jul. 9, 2025, entitled “EQUINE SLOW-FEEDER FOR SIMULATING GRAZING BEHAVIOR” by Sean Steven Fintel, having Attorney Docket No. EZGRAZER-001, the disclosure of which is hereby incorporated herein by reference in its entirety.

U.S. patent application Ser. No. 19/264,021 claims priority to and benefit of then co-pending U.S. Provisional Patent Application No. 63/671,391 filed on Jul. 15, 2024, entitled “LIVESTOCK SLOW-FEEDER” by Sean Steven Fintel, having Attorney Docket No. EZGRAZER-001-PR, the disclosure of which is hereby incorporated herein by reference in its entirety.

### BACKGROUND

Many horses and other grazing animals require consistent access to forage to maintain digestive health and overall well-being. A preferred method of supporting this natural grazing behavior, characterized by slow and steady feed intake that aids in proper nutritional assimilation, is to allow them to graze without interruption. However, when broad pasture access is limited, supplemental feeding with hay or conserved forage is commonly employed. Yet, these methods often fall short of replicating the nuances of natural grazing and can lead to challenges such as inefficient feed utilization and potential digestive stress. As a result, there is a need for improved feeding solutions that better simulate continuous, natural forage consumption while addressing the practical limitations of managed feeding environments.

Livestock health management is a critical aspect of animal husbandry, particularly for species such as horses, cattle, and other grazing animals. Early detection of health issues is essential to prevent serious conditions, reduce veterinary costs, and ensure the overall well-being of the animals. However, traditional methods of monitoring livestock health often rely on manual observation, which can be time-consuming, inconsistent, and prone to human error. Additionally, subtle signs of health problems, such as changes in posture, gait, or feeding behavior, may go unnoticed until the condition worsens, leading to costly interventions and potential loss of livestock.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 depicts an upper right and rear perspective view of a livestock animal slow-feeder with opened loading doors and in an unloaded state with no hay yet loaded inside, according to various embodiments.

FIG. 2 depicts an upper right and rear perspective view of the livestock animal slow-feeder of FIG. 1 with closed loading doors and in a fully loaded state with baled hay loaded inside and a horse that is about to begin feeding, according to various embodiments.

FIG. 3 depicts an upper right and rear perspective view of the livestock animal slow-feeder of FIG. 1 with closed loading doors and in a partially loaded state with baled hay loaded inside, but which has been fed on by a horse for long enough that the grid panels have traveled inward to continually compress the hay as it has been diminished by the feeding of the horse, according to various embodiments.

FIG. 4 depicts a right-side elevational view of the livestock animal slow-feeder of FIG. 1 with closed loading doors and in a loaded state with hay loaded inside, according to various embodiments.

FIG. 5 depicts a front elevational view of the livestock animal slow-feeder of FIG. 1 with closed loading doors and in a loaded state with hay loaded inside, according to various embodiments.

FIG. 6 depicts a left-side elevational view of the livestock animal slow-feeder of FIG. 1 with closed loading doors and in a loaded state with hay loaded inside, according to various embodiments.

FIG. 7 depicts a rear elevational view of the livestock animal slow-feeder of FIG. 1 with closed loading doors and in a loaded state with hay loaded inside, according to various embodiments.

FIG. 8 depicts a rear elevational view of the livestock animal slow-feeder of FIG. 1 with opened loading doors and in a loaded state with hay loaded inside, according to various embodiments.

FIG. 9A illustrates a rear perspective view of an example adjustable grid element holder which holds and facilitates adjustably spacing grid elements in a feed-through grid panel and in which the faceplate of the bracket holder is in a lowered position to secure the grid elements, in accordance with various embodiments.

FIGS. 9B-1 and 9B-2 illustrate side detail views of a portion of the adjustable grid element holder of FIG. 9A and depict operation of the faceplate of the bracket holder, which is movable to facilitate adjustment of the spacing between grid elements, in accordance with various embodiments.

FIG. 9C illustrates a rear perspective view of an example adjustable grid element holder which holds and facilitates adjustably spacing grid elements in a feed-through grid panel and in which the faceplate of the bracket holder is in a raised position to facilitate adjustment of the grid elements, in accordance with various embodiments.

FIG. 9D illustrates a side view of the adjustable grid element holder of FIGS. 9A and 9C, which depicts the adjustment of the spacing between grid elements, in accordance with various embodiments.

FIG. 10 illustrates an example of a health-monitoring feeder, in accordance with various embodiments.

FIG. 11 is a system-level block diagram of the electronic portions of the health-monitoring feeder of FIG. 10, in accordance with various embodiments.

FIGS. 12A-12C illustrate some examples of images of a livestock animal (a horse in this example) that are captured by imaging devices of the livestock animal slow-feeder with proactive health monitoring of FIG. 10, in accordance with various embodiments.

FIGS. 13A-13B illustrate some examples of images of a second livestock animal (a second horse in this example) that are captured by imaging devices of the livestock animal slow-feeder with proactive health monitoring of FIG. 10, in accordance with various embodiments.

FIG. 14 illustrates an example of a remote server, which may receive captured images and other data from a health-monitoring feeder of FIG. 10 for remote analysis, in accordance with various embodiments.

FIG. 15 is a schematic block diagram which, according to various embodiments, illustrates the integration of the health-monitoring feeder of FIG. 10 with a remote server for data processing and health analysis, in accordance with various embodiments.

FIG. 16A is a schematic system diagram which illustrates the transmission of health alerts and feeding summaries from the health-monitoring feeder to a mobile device via a wireless communications network, in accordance with various embodiments.

FIG. 16B is a schematic system diagram which illustrates the transmission of captured images and other data from the health-monitoring feeder to a remote server for analysis and processing, and the additional transmission of health alerts and feeding summaries from the remote server to a designated mobile device or designated application via a wireless communications network, in accordance with various embodiments.

FIG. 17 illustrates an example method flow diagram for proactively monitoring the health of livestock animals, in accordance with various embodiments.

FIG. 18 illustrates a method flow diagram for proactively monitoring the health of livestock animals with a health-monitoring feeder, in accordance with various embodiments.

### DETAILED DESCRIPTION

Reference will now be made in detail to various embodiments of the subject matter, examples of which are illustrated in the accompanying drawings. While various embodiments are discussed herein, it will be understood that they are not intended to limit these embodiments. On the contrary, the presented embodiments are intended to cover alternatives, modifications, and equivalents, which may be included within the spirit and scope of the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well-known methods, procedures, components, and circuits have not been described in detail so as not to unnecessarily obscure aspects of the described embodiments.

### Overview of Discussion

A slow-feeder is described herein that brings a more natural feeding solution than conventional free-feeding livestock feeders. The slow-feeder described herein adds a small amount of difficulty to feeding on organic material, such as hay, which is loaded into the slow-feeder. This increased difficulty is promoted by at least two aspects: 1) by continually compressing the organic material as feeding diminishes the amount of organic material in the slow-feeder; and 2) by providing only small gaps through which the livestock animal(s) can grasp and pull out the compressed organic material with their mouth parts. These aspects of added difficulty simulate slow feeding in comparison to free-feeding of organic material by unrestricted access and thus simulate the natural grazing behavior of slowly biting and pulling while eating. In comparison to feeding on freely accessed hay, the elements of restricted access provided by the livestock slow-feeder described herein improve a livestock animal's health and well-being by preventing fast-eating and overeating, which can cause digestion problems like colic. The elements of restricted access provided by the livestock slow-feeder also cause a volume of organic material to last longer than it would during free-feeding, as feeding action is slowed. The restricted access and continual compression of loaded organic material also prevent breakdown of, for example, a bale of loaded hay, as frequently occurs in conventional unrestricted access bale feeders. Such bale breakdown tends to cause hay to become scattered and/or trod through, and in some cases spoiled in conventional feeders which have unrestricted access; and these problems are reduced or eliminated by the livestock slow-feeder described herein.

In general, the disclosed slow-feeder has an interior cavity for bulk loading of organic material that is being slow-fed to livestock. Typically, the organic matter will be hay of some sort that is in bale form. A variety of hay bale sizes can be accommodated in the interior of the slow-feeder-from larger rectangular bales (e.g., 4 feet by 8 feet, 5 feet square, etc.) and large round bales (e.g., 6 feet in diameter) to smaller bales (e.g., rectangular bales which may be 1.5 by 3 feet). In some embodiments, the slow-feeder described herein may also be sized for use of bales of particular dimensions and/or shapes.

The disclosed slow-feeding system for horses incorporates a two-pronged design, which combines a rolling weighted compression mechanism to simulate natural grazing behavior with advanced technological features for proactive health monitoring. Unlike existing feeders, the disclosed slow-feeding system incorporates rolling panels that compress hay using gravity and weight, ensuring horses feed in a natural posture that reduces health risks such as colic, ulcers, digestion issues, and respiratory issues. Furthermore, the feeder integrates cellular connectivity and artificial intelligence to provide real-time notifications when refilling is required and to proactively monitor equine health for a variety of diseases and ailments by analyzing gait, feeding patterns, and physical indicators through image capture and analysis. This combination of enhancing feeding efficiency while offering health diagnostics introduces a transformative solution for horse owners within the equine industry.

Herein, the disclosure is divided into two sections. Section 1 describes several embodiments of a livestock animal slow-feeder. Section 2 describes a health-monitoring feeder and system based on a livestock feeder which is configured to capture images of the livestock animal(s). This livestock feeder may be the slow-feeder of Section 1 or a generic livestock feeder which is equipped with image capture devices. The feeding system and/or the livestock feeder incorporates proactive health monitoring by including additional components such as imaging devices and, in some embodiments, a computer, coupled with the livestock feeder to enable collection of image data for one or more of: 1) training a machine learning or artificial intelligence system to differentiate between healthy and health-compromised livestock animals; 2) providing images of livestock animals using or near the livestock feeder to a person such as a caretaker, owner, trainer, or veterinarian; and 3) providing images of livestock animals using or near the livestock feeder to a trained machine learning system or artificial intelligence system for the purpose of flagging images for possible/likely health conditions which the machine learning/AI system has been trained to detect from images.

### SECTION 1

### Example Slow-feeder

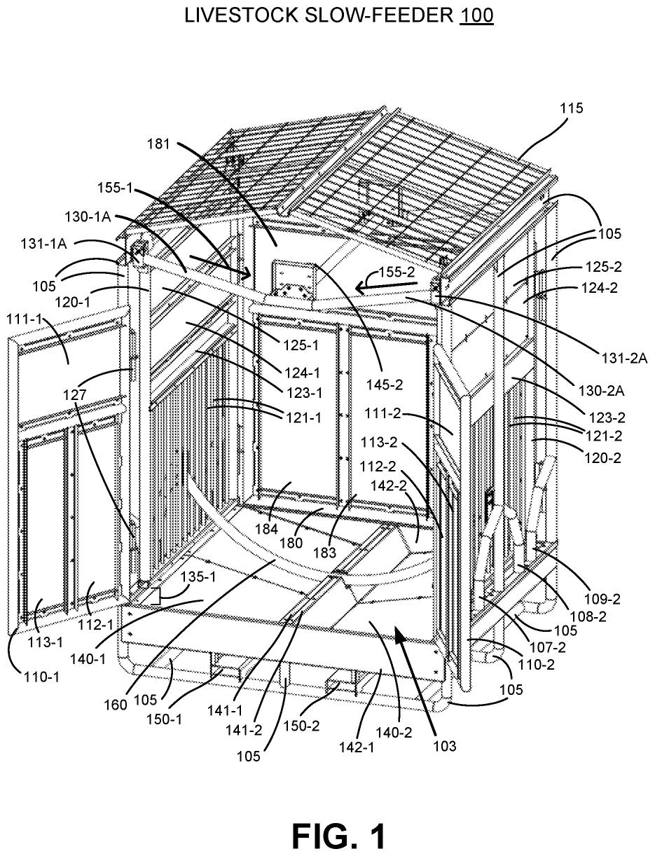

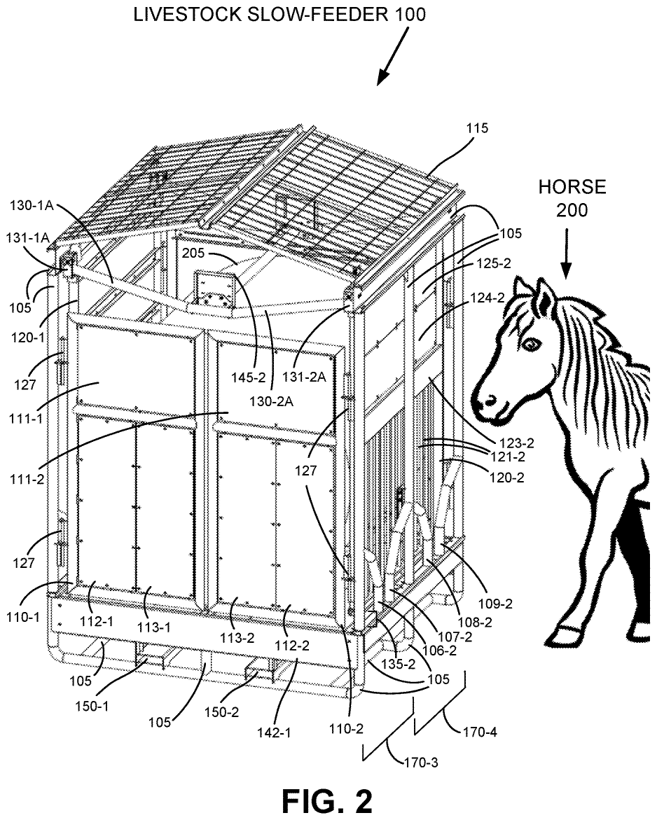

FIGS. 1-8 depict various views of a livestock slow-feeder 100, according to various embodiments. The livestock animal slow-feeder 100 comprises: an external frame 105 which defines an internal cavity 103; one or more openable side doors 110 (e.g., 110-1, 110-2) through which hay 205 (see FIG. 2) can be loaded into the interior/internal cavity 103; a set of inwardly downward sloped trolley tracks 130 (e.g., 130-1A, 130-1B, 130-2A, 130-2B) coupled with the external frame 105; and at least one feed-through grid panel 120 (e.g., 120-1 and/or 120-2) which is movably coupled to a set of trolley tracks 130 by a trolley wheel assembly 131 (e.g., 131-1A, 131-1B, 131-2A, and 131-2B). In some embodiments, the livestock animal slow-feeder 100 may additionally comprise one or more troughs 140 (e.g., 140-1 and/or 140-2); and/or one or more low hay sensors 145 (e.g., 145-1, 145-2); a roof 115; and/or one or more fork pockets 150 (e.g., 150-1, 150-2). In some embodiments, one or more hay support elements 160 may be included to support loaded hay 205 such that a bale (e.g., a large round bale) is supported off of the ground or off of the upper surface of a trough 140. In some embodiments, additional frame elements (e.g., 106, 107, 108, 109) may be included to form one or more feeding stalls 170. Although depicted as facilitating two-sided feeding, it should be appreciated that in some embodiments, slow-feeder 100 may be set up to permit only one-sided feeding.

FIG. 1 depicts an upper right and rear perspective view of a livestock animal slow-feeder 100 with opened loading doors (110-1 and 110-2) and in an unloaded state with no hay yet loaded inside, according to various embodiments. An external frame 105 is shown which encompasses and defines an internal cavity 103 into which hay may be loaded for livestock consumption. As illustrated, most of the elements of frame 105 are round tubular metal (e.g., steel), but other types of shapes of material may be utilized.

A pair of doors 110-1 and 110-2 are coupled to opposite side edges of frame 105 by hinges 127 such that the doors meet together, like saloon doors, at approximately the midline of the right side of slow-feeder 100. It should be appreciated that other door configurations may be utilized, such as a single door hinged on one side edge, a door which is hinged on the top edge rather than on a side edge, and/or a door which is hinged on the bottom edge rather than on a side edge. When both doors 110-1 and 110-2 are in an open state, as depicted in FIG. 1, there is easy access to load baled hay or other organic feed material into the open internal cavity 103 which is defined by external frame 105. Doors 110 may be solid or covered with material such that livestock are prevented from feeding through doors 110. As depicted, for example, door 110-1 includes solid sub-panels 111-1, 112-1, and 113-1 which prevent feeding access. Similarly, door 110-2 includes solid sub-panels 111-2, 112-2, and 113-2 which prevent feeding access. One or more latches or locks may be provided to secure doors 110-1 and 110-2 in the open position or in a closed position.

Above the doors 110, there are two sets of inwardly downward sloped trolley tracks 130 (e.g., first set 130-1A and 130-1B; and second set 130-2A and 130-2B) coupled with the external frame 105 and configured to slope downward from the outer edges toward the middle of slow-feeder 100. The angle of downward slope may be between 5 degrees and 50 degrees in various embodiments. In some embodiments, the angle of downward slope is between about 15 degrees and 30 degrees. In some embodiments, the angle of downward slope is between about 20 degrees and 35 degrees. As depicted, the trolley tracks 130 are round tubular metal similar to or the same as frame 105 and function in a secondary capacity to add additional structural stability to frame 105 by connecting the top of the front of frame 105 to the top of the rear of frame 105. The trolley tracks 130 are configured to interface with caged rollers/wheels of their associated trolley wheel assemblies 131, which are fixedly coupled to the grid panels 120. For example, trolley wheel assemblies 131-1A and 131-1B are coupled to each of the two top corner edges of grid panel 120-1 to facilitate grid panel 120-1 rolling downhill in direction 155-1 on trolley tracks 130-1A and 130-1B. Similarly, trolley wheel assemblies 131-2A and 131-2B are coupled to each of the two top corner edges of grid panel 120-2 to facilitate grid panel 120-2 rolling downhill in direction 155-2 on trolley tracks 130-2A and 130-2B. Although two track/trolley combinations are illustrated as being coupled with each grid panel, in some embodiments, a single track/trolley combination may be utilized (such as on a midline), or more than two may be utilized (such as one on each upper corner and one on the upper middle of a grid panel 120).

Two feed-through grid panels 120 (e.g., 120-1 and/or 120-2) are depicted, with one each on opposite ends of slow-feeder 100, such that hay 205 is loaded between them and then continually compressed between them by the force of gravity (gravity continually affects the downhill rolling of the feed-through grid panels 120), causing each grid panel 120 to press and roll inwardly toward the midline of slow feeder 100 on the trolley tracks 130 to which each grid panel 120 is movably coupled by its respective trolley wheel assembly/assemblies 131. As depicted, the top portion (approximately the top half) of each grid panel 120 is occluded by solid sub-panels (124-1 and 125-1 in panel 120-1; and 124-2 and 125-2 in panel 120-2) to prevent an animal from feeding through the top of the panel. In some embodiments, one or more of these solid sub-panels 124 and 125 in each grid panel 120 may be adjustable or removed completely for larger animals or larger/differently shaped bale types. If removed, the removed sub-panel may be left open or replaced with grid material similar to or the same as that used in the bottom portion of grid panel 120, or the grid material from the bottom portion of grid panel 120 may be extended upwards. The ability to remove/alter the sub-panels 124 and 125 in the top portion of a grid panel 120 also provides adjustability for different sizes of bales and for weathered bales, which, due to age or prior exposure to elements, have a non-uniform shape and/or do not flow as well within the slow-feeder 100 during consumption by livestock as would a newer, less weathered, or more uniformly shaped bale 205.

The bottom portion (again, approximately the bottom half) of each grid panel 120 has spaced-apart grid elements 121 (e.g., 121-1 in panel 120-1 and 121-2 in panel 120-2) composed of wire, metal bars, pipes, tubing, nylon filament, nylon strapping, Kevlar strapping, or other suitable grid material. Although only vertical parallel grid elements are shown, other arrangements, such as horizontal grid elements 121 or crossing grid elements 121, may be employed. Additionally, in some embodiments, the horizontal spacing between vertical grid elements 121 may be purposefully non-uniform. The grid elements 121 may be of any suitable shape and separation that is suitable to both compress the surface of baled hay 205 and to also expose just enough access to strands of hay in the baled hay such that the lips, tongue, and/or teeth of a horse 200 or other livestock animal can grasp strands of the hay 205 and pull them free, with some effort, while feeding.

In some embodiments, half-inch metal tubing may be used for grid elements 121 and may be spaced on centers of between 1.5 inches and 10 inches (e.g., 2.75 inches on center), in various embodiments, to provide adjustments for hay availability per bite. In some embodiments, the vertical grid elements 121 may be replaced by a nylon grid which has openings through which hay may be consumed by an animal. Such a grid may have openings that are sized anywhere between 0.5 inches square (or 0.5 inches in diameter if the shape is not square) up to 7 inches square (or 7 inches in diameter if the shape is not square). For example, a nylon grid may have square openings that are 1.75 inches by 1.75 inches. The size of the openings in a nylon grid may be selected to be larger within this range to increase feed availability or smaller within this range to decrease feed availability. It should be appreciated that, in some embodiments, the openings/spacings of grid elements may not be regular (e.g., 3 inches between a first set of grid elements and 2 inches between another second set of grid elements) and may not be uniform in dimension (e.g., an opening may be an elongated rectangle, rather than a square).

In some embodiments, the grid panel 120, grid elements 121, or the portion of a grid panel 120 which includes the grid elements 121 may be replaced to allow for adjustment of the spacing and/or shapes of openings between grid elements 121. Thus, the spacing between grid elements may be decreased to make simulated grazing more difficult or increased to make simulated grazing less difficult. This facilitates configuring a grid panel 120 to simulate different grazing conditions; configuring a grid panel 120 for use by different types of animals (e.g., cattle, horses, goats, llamas) which graze in differing manners; and/or configuring a grid panel 120 for varying ages (young, adult, geriatric), health levels, and/or diets. For example, larger spacing between grid elements 121 may be employed for cattle than for horses. Similarly, small grid spacing may be employed for a colt, medium grid spacing may be employed for an adult horse, and large grid spacing may be employed for a geriatric horse. Likewise, a smaller spacing may be employed for a healthy animal and a larger spacing may be employed for a sick animal which is not at full strength. In a like manner, grid spacing for an animal on a restricted diet (i.e., such as to lose weight) may be restricted compared to grid spacing employed for an animal of the same type which is not on a restricted diet. In other embodiments, spacing between grid elements 121 may be altered for factors such as the type of organic matter being fed and/or how tightly the organic matter is baled.

The grid panel(s) 120 are designed and configured to press against hay 205 in response to gravity causing the panel(s) to roll downhill and compress portions of the baled hay 205 which are retained behind grid panel(s) 120. The pressure of the grid panels 120 against the baled hay 205 also causes the livestock animal(s) to have to exert more force to pull strands of hay from the baled hay 205 than would be required to eat loose hay, and this force helps replicate the force required to bite or pull organic matter from pasture ground while grazing. This, combined with the narrow spaces between grid elements 121, prevents a horse from quickly consuming the hay 205 and becoming ill and also provides a self-metering effect which slows feeding compared to eating directly from a bale not held in compression (due to the additional force required to pull a strand of hay loose during feeding) and causes the baled hay to last for a longer period of time than if it were loose and easier for the horse 200 to consume.

In some embodiments, panels 120-1 and 120-2 may be latched or otherwise secured to frame 105 in the fully spread apart orientation that is illustrated in FIG. 1 to facilitate loading hay 205 into hay receiving cavity 103 without concern about the panels 120 rolling inward during loading. After loading hay 205, the panels 120 can be unsecured and allowed to roll down and inward to compress against the loaded hay 205. In various embodiments, the weight of a grid panel 120 may scale up or down depending on the size of the grid panel 120. In one example of the depicted embodiment, which holds a large round bale, the weight of a grid panel 120, such as grid panel 120-1, without adding weights to the weight-holder bracket/slot 123, is between 200 and 220 pounds, but may go up or down depending on how the grid panel 120 is configured. In various embodiments, the weight of a panel may be between 150 and 300 pounds.

In some embodiments, one or more of the panels 120 may have a weight-holder bracket/slot 123 (e.g., 123-1, 123-2) which is either weighted itself (such as by being made from heavy-gauge metal) or, as illustrated in FIG. 1, is formed in a channel which is shaped to receive, hold, and secure a plurality of weighty items such as standard-size cinder blocks (e.g., solid cinder blocks with dimensions of 4 inches by 8 inches by 16 inches or 2 inches by 8 inches by 16 inches) or standard concrete paver blocks (e.g., solid concrete paver blocks with dimensions of 15.5 inches by 15.5 inches by 2 inches) which can be slid into the edge of the formed channel which is nearest to an open door 110. In some embodiments, weighted items such as cinder blocks, paver blocks, or metal bars/blocks can be secured to a weight holder bracket/slot 123 to increase the mass of the grid panel and thus increase the force with which it compresses against hay 205 as it rolls inwardly downhill on its respective trolley tracks 130. For example, by installing three 4-inch by 8-inch by 16-inch cinder blocks into weight holder 123-1, about 110 pounds of weight can be added to grid panel 120-1. For example, the weight of grid panel 120-1 could be increased from about 210 pounds to about 315 pounds by adding three cinder blocks to weight holder 123-1. In this manner, adding weight to the grid panel 120 increases the compressive force it exerts and thus makes feeding more difficult and slower in comparison to not increasing the mass of the grid panel 120.

In various embodiments, the weight-holder 123 of a grid panel 120 facilitates a user-configurable amount of mass to be employed for adjusting the compressive force of the grid panel 120 against the organic matter (e.g., baled hay 205) in the receiving cavity 103. In some embodiments, a user may increase or decrease the configurable mass of the grid panel based upon factors such as: the type of organic matter being fed (e.g., less or no added mass for alfalfa, a medium amount of added mass for triticale, and a large amount of added mass for timothy hay); how tightly the organic matter is baled (e.g., less or no added mass for tightly baled hay, and more added mass for loosely baled hay); the type of animal feeding at the slow feeder 100 (e.g., less mass may be added for a cow than for a horse); the age of the animal feeding at the slow feeder 100 (e.g., less mass may be added for an adult horse than for a geriatric horse); and/or the health of the animal (e.g., less mass may be added for a sick horse than for a healthy horse); and/or for dietary purposes (e.g., less or no mass may be added for a horse with no dietary restrictions and more mass may be added for a horse which is on a calorically restricted diet).

It follows that the combination of user-configurable mass of a grid panel 120 and user-configurable spacing of grid elements 121 (or openings in a feed-through grid) in a grid panel 120 facilitate a large amount of configuration of the slow feeder for: different types of animals; different health conditions of animals; different ages of animals; different health conditions of animals; different caloric needs of animals; different grazing conditions being simulated; different organic matter being fed; and differing tightness of the baling of the organic matter being fed. For example, a user may increase the hay compressing mass by adding two cinder blocks to the weight-holder 123 of a grid panel 120 and utilizing grid elements 121 with a spacing which gives a 1.75-inch opening between grid elements 121 to establish a first feed rate governed by a combination of the compressive force and spacing of the grid elements 121. A second and faster feed rate for the same animal may be established by removing one or both of the cinder blocks from the weight-holder 123 of the grid panel 120, increasing the spacing of grid elements to provide openings of 2 inches, or both.

In some embodiments, when included, trough(s) 140 (e.g., 140-1 and/or 140-2) are coupled to the external frame 105, forming a bottom boundary of the internal cavity 103, and are configured to capture and hold stray/dislodged hay which falls from baled hay 205 during feeding such that the falling hay does not land on the ground beneath the slow feeder to be trampled and/or spoiled, but instead is still easily accessible to the livestock animal such that it may be eaten by the livestock animal reaching through the grid panel 120 to retrieve the hay from the surface of a trough 140. In this manner, spoilage and waste are reduced as compared to feeders which permit stray/dislodged hay to fall on the ground and/or into areas which are inaccessible to the feeding livestock animal. In some such embodiments, one or more holes (not depicted) may be disposed in the bottom of trough(s) 140 to prevent retention of water (such as from rain). In some embodiments, the trough(s) 140 are angled downward from the left and/or right sides of the slow-feeder toward the middle of the slow feeder. In some embodiments, the angle of downward slope is similar to or the same as the downward slope of the inwardly downward sloped trolley tracks 130, such that as a grid panel 120 above a trough 140 rolls inwardly and downhill due to the effect of gravity as the hay 205 is diminished through feeding, the bottom edge of the grid panel 120 maintains substantially the same distance of separation from the upper surface of the trough 140 throughout its inward travel. The similarity between or matching downhill slopes between a trough 140 and the trolley tracks vertically above it further facilitates slow-feeding by keeping a fixed or substantially fixed, gap 135 (135-1 visible in FIG. 1; 135-2 visible in FIG. 2) of between about 1 inch and 4 inches between the bottom edge of grid panel 120 and the top surface of trough 140. In some embodiments, the fixed/substantially fixed gap 135-1 is between 2.5 inches and 3.5 inches, with a target gap of about 3 inches. By “substantially fixed” what is meant is that there could be some variation in the size of the gap 135 of up to about 1.5 inches when panel 120 is not completely vertical or due to a slight mismatch between the slope of a trough 140 and its vertically corresponding trolley tracks 130. Because the fixed/substantially fixed gap 135 does not widen at all or does not widen much as grid panel 120 moves inward during consumption of hay bale 205, this prevents more hay from being available in the trough 140 and also prevents a livestock animal from getting increasing access to a contained bale 205 from a large or increasingly large gap 135 beneath the grid panel 120 and a trough 140 as the grid panel 120 moves inward. This also maximizes the volume of hay bale 205 that is kept behind a grid panel 120 as the grid panel 120 moves inward, by not allowing hay to easily spread from the bottom of the bale 205 and through a large or increasing gap 135 between the grid panel 120 and the trough 140. As depicted, hay trough 140-1 has a downhill slope from left to right until a midline stop 141-1 is reached, while hay trough 140-2 has a downhill slope from right to left until a midline stop 141-2 is reached. The stop mechanisms (midline stops 141-1 and 141-2) prevent the feed-through grid panels 120 from moving beyond a predetermined position. In some embodiments, the position of midline stops 141-1 and 141-2 is fixed, while in others it is user-adjustable. In some embodiments, where the troughs 140-1 and 140-2 are separate elements, each may be coupled to frame 105 and then the midline stops 141-1 and 141-2 abutted against one another such that the troughs 140-1 and 140-2 are mirror images of one another. It should be appreciated that the depicted set of troughs 140-1 and 140-2 may alternatively be formed of a single sheet of material and/or of a plurality of assembled pieces of material. As depicted, side sills 142-1 and 142-2 may be mounted to frame 105 to form right and left sides, respectively, of the troughs 140. For example, side sill 142-1 forms the right side of troughs 140-1 and 140-2, while side sill 142-2 forms the left side of troughs 140-1 and 140-2.

One or more low hay sensors 145 (e.g., 145-1, 145-2), when included, may be configured to provide a wired or wireless notification in response to hay contained in the internal cavity 103 reaching a predetermined level associated with being “low” and needing to be refilled either immediately or within a predetermined period of time (such as within 12 hours, 24 hours, or some other time). In some embodiments, a low hay sensor 145 may be a cellular device coupled with a switch which is actuated by being compressed by a trolley wheel assembly 131 when a panel 120 rolls inwardly on its respective trolley tracks 130 to a predefined location associated with enough hay 205 having been eaten that a low hay notification is triggered to alert that a refill of hay is needed soon. In some embodiments, a low hay sensor 145 may be a wireless contact sensor, magnetic sensor, hall effect sensor, or the like with a direct cellular connection or a Wi-Fi connection to report contact being made, a status change of contact vs. no-contact, and/or to report the current status of the sensor (i.e., contact or no-contact) on a recurring basis or in response to polling. In some embodiments, a low hay sensor 145 may be a photo sensor or optical camera coupled with a cellular device, and which is configured to send a photo of the contained hay bale 205 at recurring intervals, at a particular time, and/or in response to being triggered such as by a contact switch on/near the trolley tracks 130. In some embodiments, a low hay sensor 145 may be a proximity/ranging sensor (such as an optical or ultrasonic sensor) coupled with a cellular device and downwardly facing from roof 115 into cavity 103, and which is configured to send a measurement of the distance from the sensor to the hay bale 205 at recurring intervals, at a particular time, and/or in response to the distance exceeding a preestablished threshold (e.g., 5 feet or 7 feet) which is associated with hay being low enough to need imminent replacement. In some embodiments, a particular message may be sent by the low hay sensor 145, such as a text message to a pre-programmed cellular phone number or an email message to a pre-programmed email address, and/or a message (e.g., a push notification) that is viewable in a paired application resident on a cellular phone or other computing device. An example of such a message is, “The hay in slow-feeder number 5 reached a low level at 4:11 P.M. on Wednesday, Jun. 19, 2024, and should be replaced within 12 hours.” Another example of such a message is, “EZ-Grazer low hay alert.” A non-limiting example of a wireless contact sensor with a direct cellular connection that may be used as a low hay sensor 145 is the Flex Aware wireless contact sensor sold by All Aware, LLC of Lawrence, Kansas.

In some embodiments, the slow-feeder 100 may additionally include an openable or removable roof 115 which may be coupled to external frame 105. As depicted, the roof 115 is wire, but may be solid such as wood or sheet metal, or the wire roof 115 may be covered with a waterproof material such as plastic sheeting, weatherproof vinyl material, a weatherproof tarpaulin, or other suitable material. In some embodiments, a combination of materials may be used such as plywood which is then covered by a tarpaulin. Typically, a weatherproof material is utilized which is thick enough or capable of being secured well enough to prevent any flapping due to wind, as such flapping could spook a livestock animal such as a horse and thus deter access to the slow-feeder 100. In some embodiments, the weatherproof material is UV resistant in addition to being waterproof. In some embodiments, roof 115 may be removed, while in other embodiments roof 115 is designed to be fixedly coupled with external frame 105 and not typically removed.

In some embodiments, slow-feeder 100 may additionally include a pair of fork pockets 150 (e.g., fork pockets 150-1 and 150-2) which are coupled with external frame 105 and which are configured to receive a pair of load lifting forks from a front-end loader or forklift and thus facilitate the ability to safely lift and/or move slow-feeder 100 with such machines. The fork pockets 150 are depicted at the bottom of slow-feeder 100, below doors 110, but may be located in any suitable position including on the same side as a grid panel 120 and on the top of frame 105 rather than beneath it.

One or more hay support elements 160, when included, may be provided near the bottom of the internal cavity 103 formed by frame 105 and may couple with two or more sides of the frame 105. As depicted, hay support element 160 is arc-shaped, which provides support, in particular, to a large round hay bale 205 and may match the general arc of the circumference of a large round bale, which frequently has a circular cross-section with about a 6-foot diameter. Although only one hay support element 160 is illustrated, a plurality may be employed. In other embodiments, where the slow-feeder is designed to work with square or rectangular bales, hay support element 160 may be straight, with no arc.

The opposite side of livestock slow-feeder 100, from doors 110, may include a similar set of doors or a solid panel. As depicted, a solid panel 180 is mounted to frame 105, such as by knuckle and pin connectors. Like doors 110, panel 180 may be made of a solid material or include solid sub-panels (e.g., 181, 182, 183, and 184), which prevent feed-through access by livestock.

FIG. 2 depicts an upper right and rear perspective view of the livestock animal slow-feeder 100 of FIG. 1 with closed loading doors 110-1 and 110-2 and in a fully loaded state with baled hay 205 (a large round bale) loaded inside and a horse 200, which is about to begin feeding, according to various embodiments. FIG. 2 more fully depicts additional frame elements 106-2, 107-2, 108-2, and 109-2, which have been included to form feeding stalls 170-3 and 170-4. For example, additional frame elements 106-2, 107-2 are arc-shaped or in the shape of a segmented arc and couple with adjacent vertical elements of frame 105 to form the shape of feeding stall 170-3. Similarly, additional frame elements 108-2, 109-2 are arc-shaped or in the shape of a segmented arc and couple with adjacent vertical elements of frame 105 to form the shape of feeding stall 170-4.

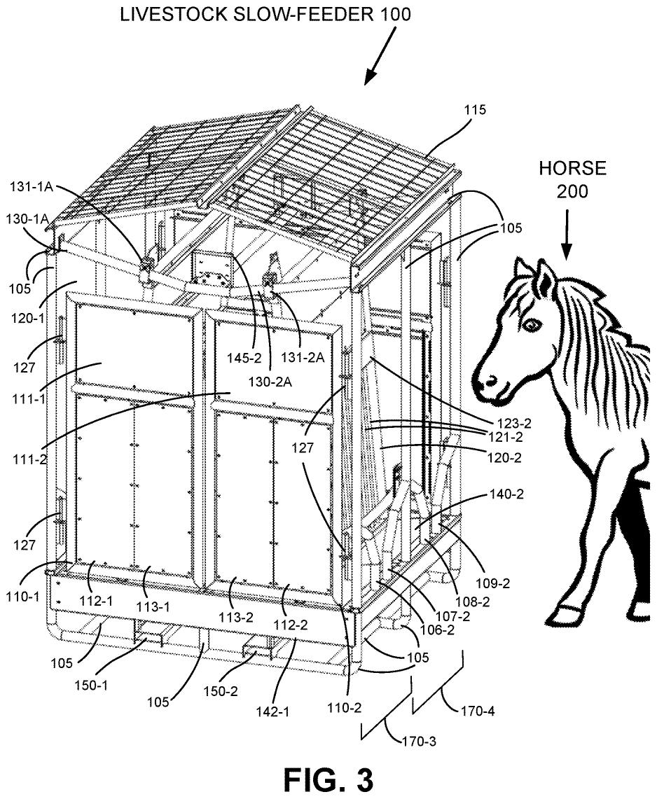

FIG. 3 depicts an upper right and rear perspective view of the livestock animal slow-feeder 100 of FIG. 1 with closed loading doors 110-1 and 110-2 and in a partially loaded state with baled hay 205 loaded inside, but which has been fed on by horse 200 for long enough that the grid panels 120-1 and 120-2 have traveled inward on their respective trolley tracks 130 to continually compress the hay as it has been diminished by the feeding of horse 200, according to various embodiments. Due to the inward movement of the grid panels 120, a portion of trough 140-2 is visible between grid panel 120-2 and frame 105 and is accessible for horse 200 to feed upon any loose hay that has been collected thereon.

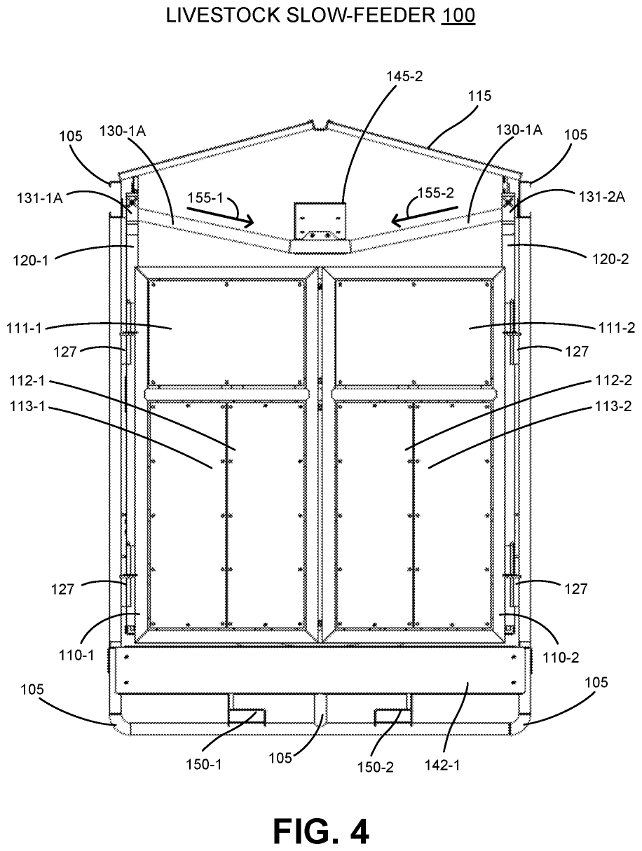

FIG. 4 depicts a right-side elevational view of the livestock animal slow-feeder 100 of FIG. 1 with closed loading doors 110 and in a loaded state with hay 205 loaded inside, according to various embodiments.

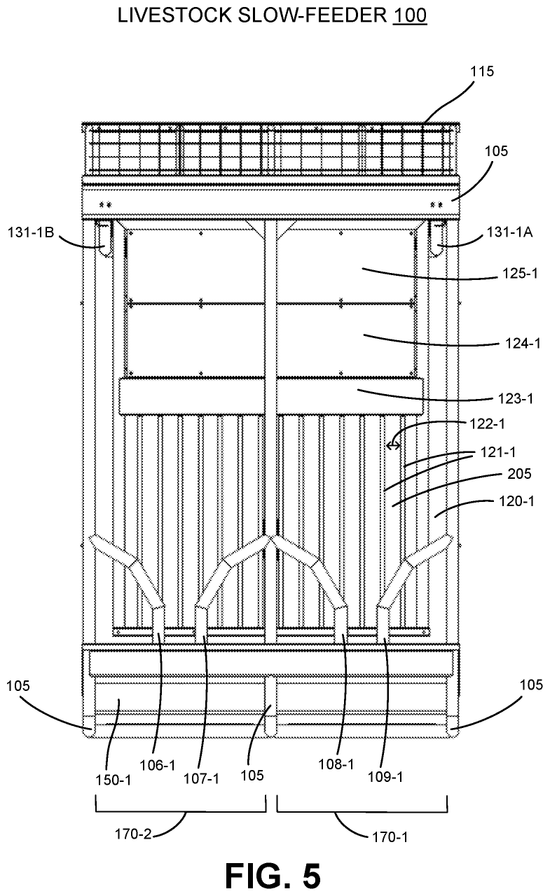

FIG. 5 depicts a front-side elevational view of the livestock animal slow-feeder 100 of FIG. 1 with closed loading doors 110 and in a loaded state with hay 205 loaded inside, according to various embodiments. Feeding space 122-1 is a purposefully narrowed space through which the mouth of a livestock animal, such as horse 200, can grasp small bites of hay 205, is visible between spaced-apart grid elements 121-1. In some embodiments, a feeding space may be between 1 inch and 3 inches in width. A plurality of similar feeding spaces for livestock animals to access hay 205 are presented between others for the adjacent grid elements 121-1 of grid panel 120-1. FIG. 5 also depicts additional frame elements 106-1, 107-1, 108-1, and 109-1, which have been included to form feeding stalls 170-1 and 170-2. For example, additional frame elements 106-1, 107-1 are arc-shaped or in the shape of a segmented arc and couple with adjacent vertical elements of frame 105 to form the shape of feeding stall 170-1. Similarly, additional frame elements 108-1, 109-1 are arc-shaped or in the shape of a segmented arc and couple with adjacent vertical elements of frame 105 to form the shape of feeding stall 170-2.

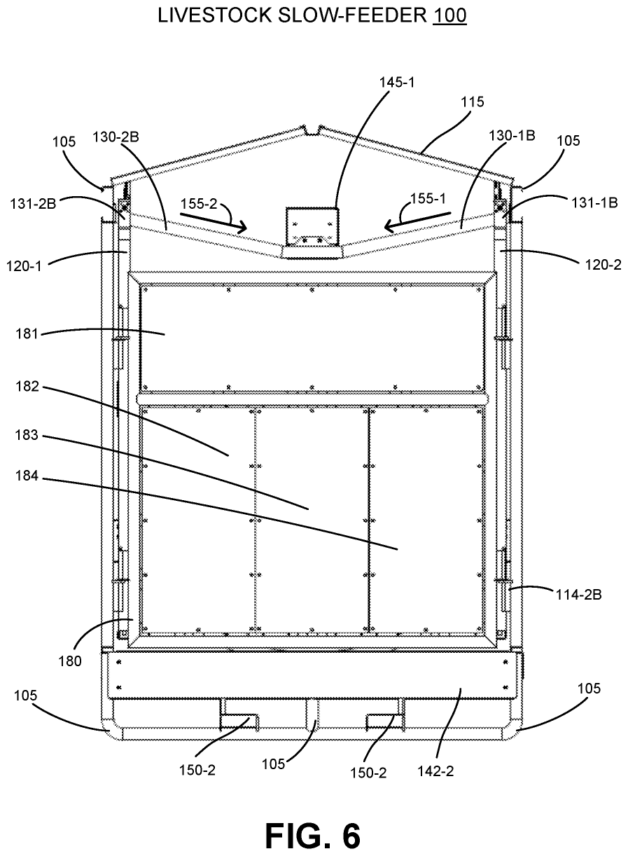

FIG. 6 depicts a left-side elevational view of the livestock animal slow-feeder 100 of FIG. 1 with in a loaded state with hay 205 loaded inside, according to various embodiments. As depicted, a solid panel 180 is mounted to frame 105, such as by knuckle and pin connectors. Like doors 110, panel 180 may be made fully of a solid material or include solid sub-panels (e.g., 181, 182, 183, and 184), which prevent feed-through access by livestock on this left side of the livestock slow-feeder to encourage the livestock animals to feed through grid panels 120-1 and 120-2.

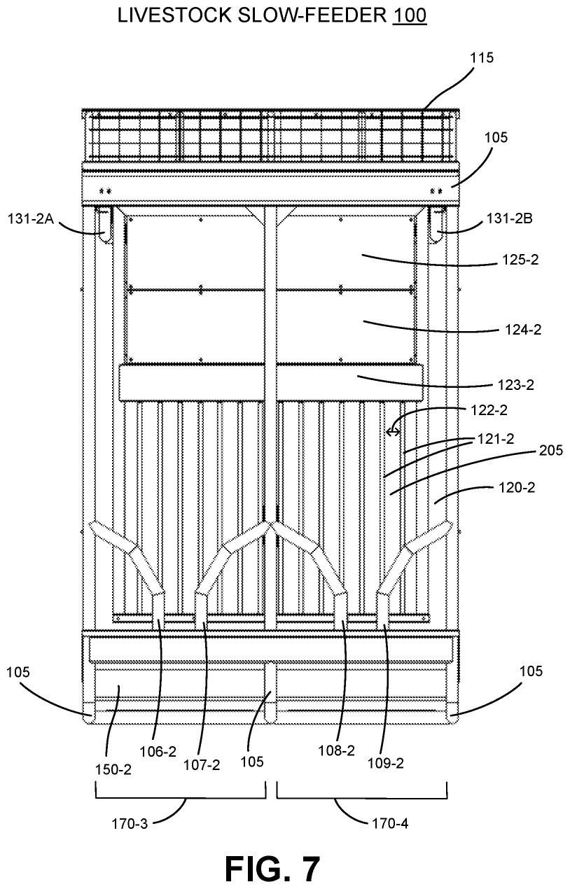

FIG. 7 depicts a rear elevational view of the livestock animal slow-feeder 100 of FIG. 1 with closed loading doors 110 and in a loaded state with hay 205 loaded inside, according to various embodiments. Feeding space 122-2 is a purposefully narrowed space through which the mouth of a livestock animal, such as horse 200, can grasp small bites of hay 205, and is visible between spaced-apart grid elements 121-2. In some embodiments, a feeding space 122 may be between 1 and 3 inches in width. A plurality of similar feeding spaces for livestock animals to access hay 205 are presented between others for the adjacent grid elements 121-2 of grid panel 120-2.

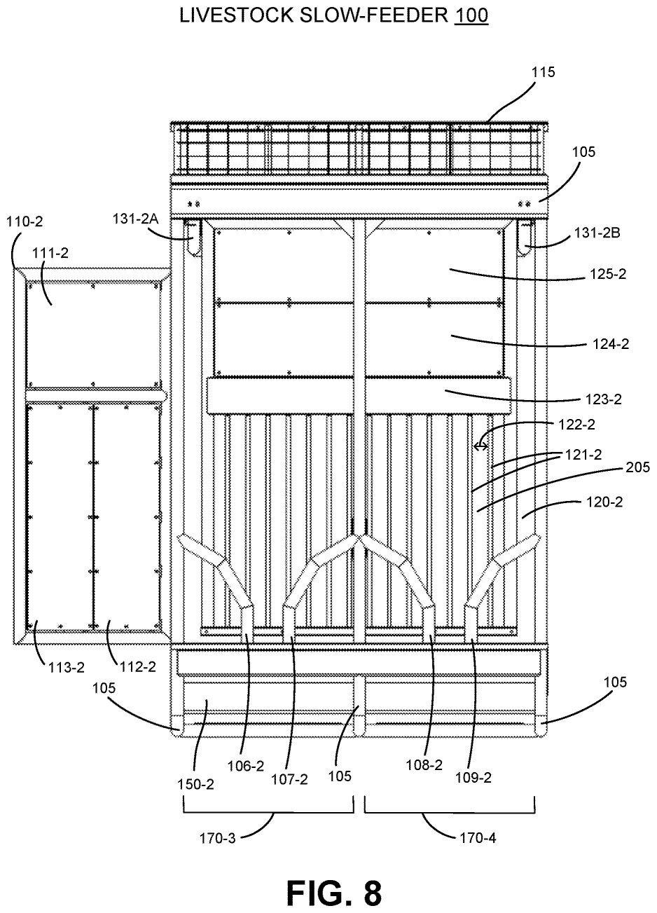

FIG. 8 depicts a rear elevational view of the livestock animal slow-feeder 100 of FIG. 1 with opened loading doors 110 and in a loaded state with hay 205 loaded inside, according to various embodiments.

### Modularity

In some embodiments, slow-feeder 100 is comprised of a variety of modules that can be bolted together or otherwise assembled in place. For example, components of external frame 105 may be flat-packed for shipping and assembled on site into the cube-like shape that is depicted in FIGS. 1-8. Likewise, doors 110, roof 115, grid panels 120, and panel 180 may be shipped in a flat-packed state and assembled/installed on site. This modular nature, as opposed to being either fully assembled and/or having a fully welded-up frame 105, facilitates a lower cube volume for ease of shipping and reduced shipping charges. In some embodiments, the modularity also facilitates user configurability, such as by removing grid panels 120 to only have stalls 170 for feed through to a hay bale 205 that is elevated off the ground. In some embodiments, as described further below, the hay bale 205 may be netted with a hay net. Additionally, or alternatively, doors 110 and/or panel 180 may be removed from the sides and replaced by panels with stall configurations similar to stalls 170 to facilitate feeding from all four vertical sides of slow-feeder 100.

### Adjustable Grid-Elements

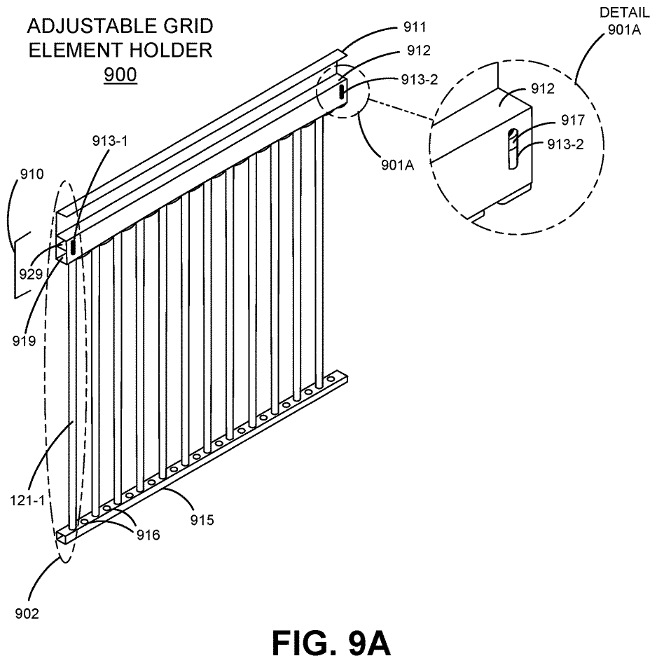

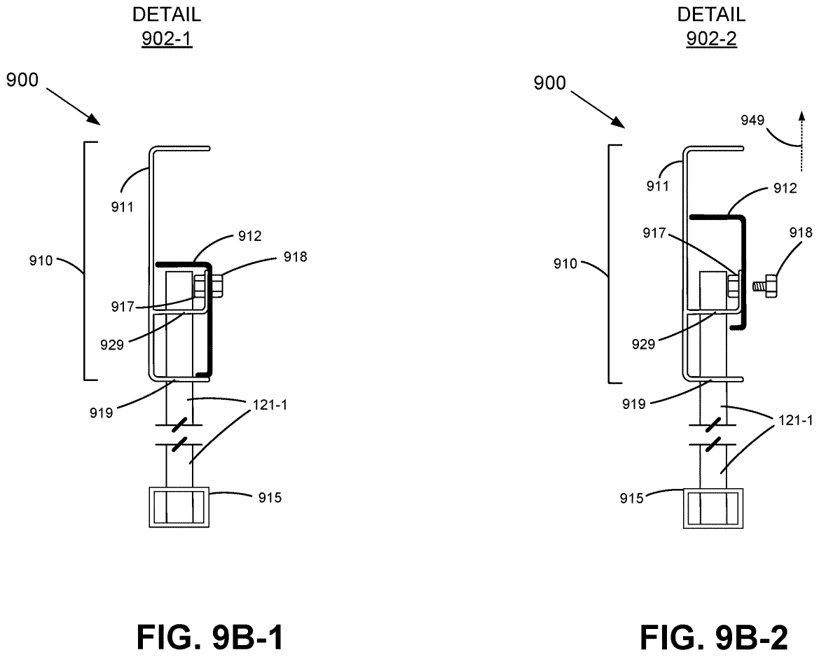

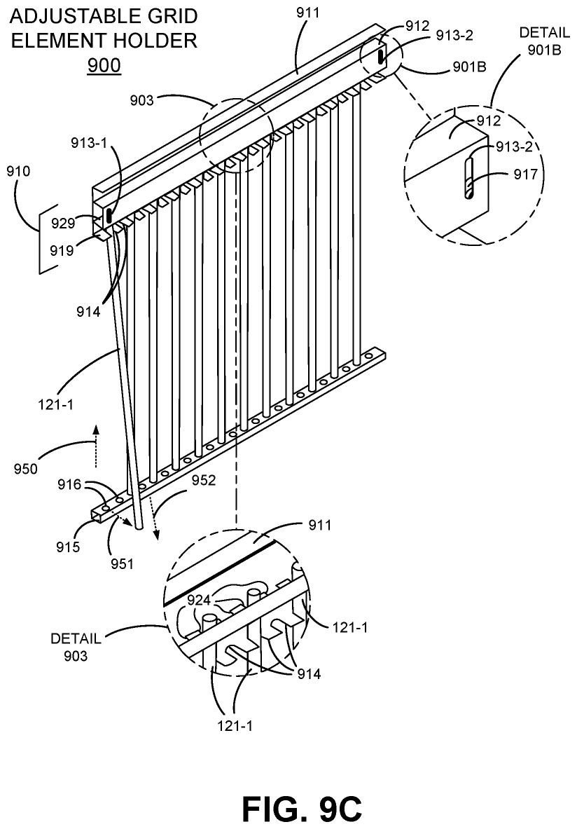

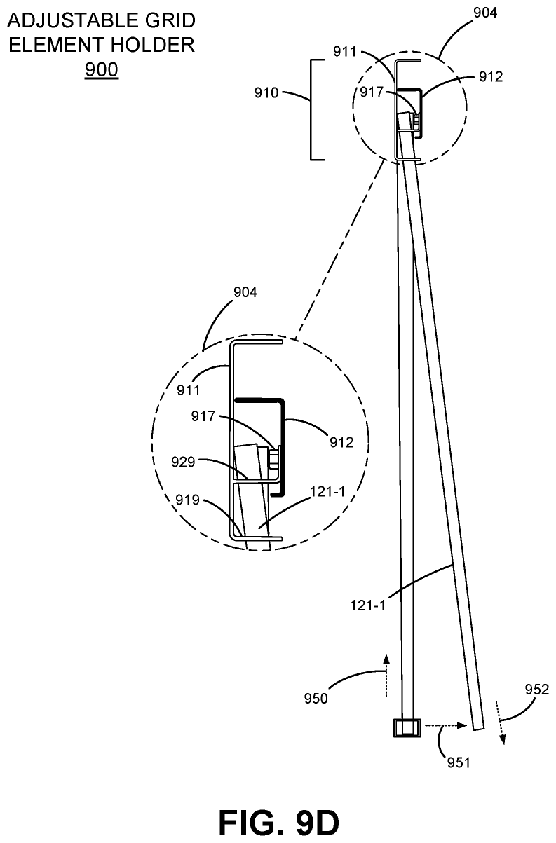

FIG. 9A illustrates a rear perspective view of an example adjustable grid element holder 900 which holds and facilitates adjustably spacing grid elements 121 in a feed-through grid panel 120 and in which the faceplate 912 of the bracket holder 910 is in a lowered position to secure the grid elements 121, in accordance with various embodiments. Bracket holder 910 comprises a backing plate 911 and a faceplate 912. In FIG. 9A, a bracket holder 910 is illustrated which has slots 913 (913-1 and 913-2) on each end of removable/movable faceplate 912. The slot 913-2 on the right end is more visible in enlarged detail 901. Each of the slots 913 provides a thru-hole oval opening for a bolt (not shown) which attaches to threads of a threaded nut affixed to a backing plate 911 disposed behind faceplate 912.

Backing plate 911 is configured to be fixedly or removably attached to a grid panel 120. In the illustrated example, round metal pipes are utilized for the grid elements 121-1 and are secured in place by the exterior halves (backing plate 911 and faceplate 912) of bracket holder 910. While the top ends of pipes 121-1 are secured in bracket holder 910, the bottom ends of the pipes used for grid elements 121-1 are seated in linearly spaced apart holes 916 of bottom stop/baseplate 915, which itself is configured to be fixedly or removably coupled to a grid panel 120.

Detail 901A illustrates the thru-hole nature of slot 913-2 and is enlarged enough that the threads of a threaded nut 917 are visible. As illustrated, faceplate 912 is in a down position in which a bolt can be threaded into threaded nut 917 and used to secure faceplate 912 in the down position which prevents removal and/or adjustment of the spacing of grid elements 121-1.

Dashed oval 902 shows the area of a side view detail which is illustrated in FIGS. 9B-1 and 9B-2.

FIGS. 9B-1 and 9B-2 illustrate side detail views 902 of a portion of the adjustable grid element holder 900 of FIG. 9A and depict operation of the faceplate 912 of the bracket holder 910, which is movable to facilitate adjustment of the spacing between grid elements 121, in accordance with various embodiments. From this side view, it can be seen that backing plate 911 has a lower extension 919 into which a plurality of outwardly facing cutouts or slots 914 (visible in detail 903) are formed and an upper extension 929 into which a plurality of inwardly facing cutouts or slots 924 (visible in detail 903) are formed. As depicted, threaded nut 917 is affixed, such as by welding, to a portion of extension 929.

In FIG. 9B-1, detail 902-1 shows faceplate 912 with its securing bolt 918 in place and securing faceplate 912 to threaded nut 917 such that faceplate 912 is held in a downward position which retains and prevents removal and/or adjustment of the spacing of grid elements 121.

In FIG. 9B-2, detail 902-2 shows faceplate 912 with its securing bolt 918 removed such that faceplate 912 can be moved to the upward position (by sliding it in direction 949) that is illustrated, after it is unsecured, which permits removal and/or adjustment of the spacing of the individual grid elements 121. It should be appreciated that securing bolts 918 may simply be loosened, without removing them, in order to unsecure the faceplate 912 so that it can then be slid upward. After grid elements 121 are inserted/removed and/or spacing is adjusted, faceplate 912 is moved back to the downward position and securing bolt 918 is resecured to threaded nut 917 so that faceplate 912 becomes secured between threaded nut 917 and the head of bolt 918. It should be appreciated that the securing bolts are bilateral and may both need to be loosened/removed to move faceplate 912 prior to manipulation of grid elements 121, and then both resecured after manipulation and replacement of faceplate 912.

FIG. 9C illustrates a rear perspective view of an example adjustable grid element holder 900 which holds and facilitates adjustably spacing grid elements 121 in a feed-through grid panel 120 and in which the faceplate 912 of the bracket holder 910 is in a raised position to facilitate adjustment of the grid elements 121, in accordance with various embodiments. The leftmost grid element 121-1 is depicted as being removed for repositioning. Such removal is effected by lifting a grid element upward in direction 950 to remove its bottom portion from its respective hole 916 (in which it is seated) of the spaced apart holes 916, then rocking it in direction 951 to give it clearance of baseplate 915, and finally pulling it downward in direction 952 to free it from bracket holder 910. The process is performed in reverse to insert or reinsert a grid element 121-1.

Detail 901B illustrates the thru-hole nature of slot 913-2 and is enlarged enough that the threads of a threaded nut 917 are visible. As illustrated, securing bolt 918 (not pictured) has been removed to free faceplate 912 for movement, and faceplate 912 has been moved to an upward position which permits removal and/or adjustment of the spacing of grid elements 121-1. It should be appreciated that faceplate 912 can be completely removed if the securing nuts through slots 913-1 and 913-2 are completely removed rather than just loosened.

Detail 903 illustrates components of bracket holder 910 which are visible after faceplate 912 is completely removed. To include slots 914 and slots 924, which are opposing slots that form the “bracket” aspect of bracket holder 910. When faceplate 912 is in the downward position and secured in place (enabling the “holder” aspect of bracket holder 910), the opposing slots 914 and 924 work together to capture the diameter of the pipes used as grid elements 121-1 and securely hold the upper ends of the grid elements 121-1 within bracket holder 910. When faceplate 912 is moved to its upper position or completely removed, the opposing slots are exposed/unconfined and removal of the grid elements 121-1 in the manner previously described is facilitated.

FIG. 9D illustrates a side view of the adjustable grid element holder 900 of FIGS. 9A and 9C, which depicts the adjustment of the spacing between grid elements 121, in accordance with various embodiments. As with FIG. 9C, the leftmost grid element 121-1 is depicted as being removed for repositioning. Such removal is effected by lifting a grid element upward in direction 950 to remove its bottom portion from its hole 916 of the spaced apart holes 916, then rocking it in direction 951 to give it clearance of baseplate 915, and finally pulling it downward in direction 952 to free it from the opposing slots 914 and 924 of bracket holder 910. The process is performed in reverse to insert or reinsert a grid element 121-1. Enlarged detail 904 illustrates the repositioning.

### Variations

In some embodiments, the grid panels 120-1 and 120-2 may be removed from the slow feeder 100 (or alternatively left in place, but with grid elements 121 removed) and a bale of hay which has been netted within a hay net can then be loaded into cavity 103. A “hay net” is a nylon net with spaced openings through which an animal can feed. A hay net is similar to a hairnet, except that it is sized to fit over a bale of hay, such as a large round bale, and it is made of more durable material. Hay nets are typically put over a bale of hay which is on the ground and outdoors in a pasture. In general, hay nets have numerous disadvantages associated with such use, including: 1) being used on hay which is laying on the ground; 2) being used on hay which does not have an environmental cover; 3) wearing out quickly; and 4) getting caught on feet, hooves, or shoes of animals. However, some or all of these particular disadvantages may be overcome by placing hay net covered bales inside cavity 103 of a slow-feeder 100. Additionally, in some embodiments, a low hay sensor 145 may be utilized with hay netted hay in slow feeder 100. For example, low hay sensor 145 may be placed on a floating arm which “floats” atop the bale that is loaded into cavity 103. When the arm “floats” downward to a predetermined level in response to feeding diminishing the size of the bale, the low hay sensor is activated by the closing of a switch positioned to coincide with the predetermined “low hay” positioning of the floating arm, and a low hay alert is sent by the low hay sensor 145.

### SECTION 2

### Health-Monitoring Feeder and Feeding System with Proactive Health Monitoring

As previously described, livestock slow-feeder 100 accommodates various bale types and offers optional protective coverings to shield hay from environmental exposure. In some embodiments, the livestock slow-feeder 100 may further include components which capture images and facilitate inclusion of artificial intelligence (AI) integration for proactive health monitoring, by using the AI to analyze horse movement and feeding behavior to detect potential ailments and send alerts to owners, caretakers, trainers, veterinarians, and other designated persons or entities. This system is designed to bring innovation to the equine industry by providing a technologically advanced solution that promotes horse health, minimizes hay waste, and delivers both peace of mind to an owner regarding the feeding and health monitoring of their livestock animal and a significant return on investment by diminishing the waste of hay (as compared to other feeders) and proactively monitoring for health concerns so that they may be promptly addressed prior to becoming more critical and costly (thus reducing veterinary costs to the owner of the livestock animal).

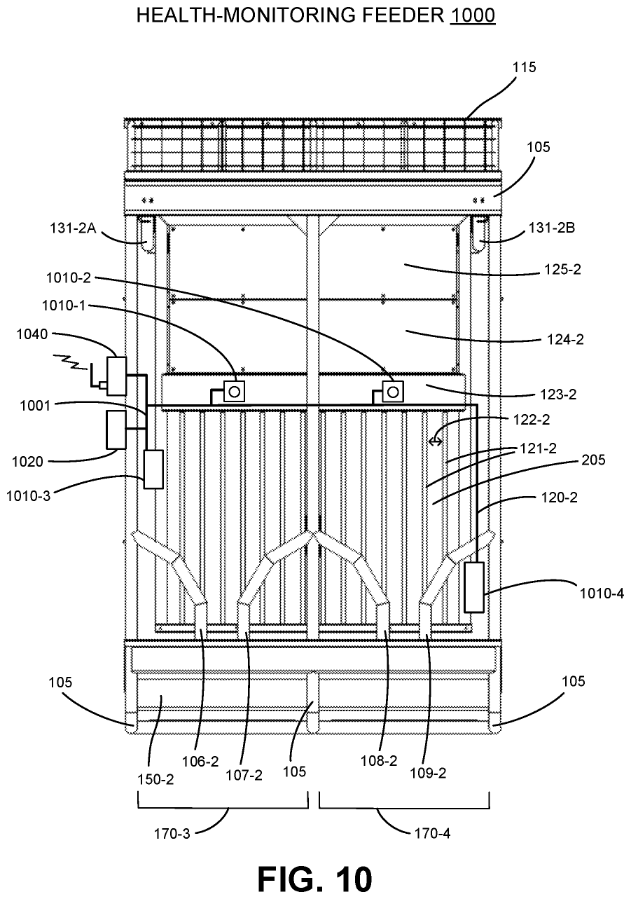

FIG. 10 illustrates an example of a health-monitoring feeder 1000, in accordance with various embodiments. Health-monitoring feeder 1000 incorporates proactive health monitoring by including additional components such as imaging devices (e.g., cameras) 1010 and, in some embodiments, a computer 1020, coupled with the livestock animal slow-feeder 100 of FIG. 1, in accordance with various embodiments. For example, health-monitoring feeder 1000 may include all the components and features of livestock slow-feeder 100 plus additional components utilized for health monitoring. In some embodiments, health-monitoring feeder 1000 additionally includes one or more imaging devices (e.g., cameras) 1010 (e.g., 1010-1, 1010-2, 1010-3, 1010-4, etc.), a wireless transceiver 1040, and, in some embodiments, a computer 1020. In other instances, a generic livestock animal feeder (rather than the slow feeder 100) may be configured as a health-monitoring feeder by similarly equipping it with one or more imaging devices (e.g., cameras) 1010 (e.g., 1010-1, 1010-2, 1010-3, 1010-4, etc.), a wireless transceiver 1040, and, in some embodiments, a computer 1020.

Imaging device(s) 1010 comprise one or more cameras configured for capturing still or moving digital images. In some embodiments, imaging device(s) 1010 are mounted on the health-monitoring feeder 1000 and are configured to capture still or video images of livestock animals as they approach and interact with the feeder. In some embodiments, some or all of the imaging devices 1010 capture images in the visible spectrum. In some embodiments, one or more of the imaging devices 1010 is/are additionally or alternatively configured to capture images in the infrared spectrum. In some such embodiments, these imaging devices 1010 are strategically positioned to capture both frontal and side views, thereby enabling detailed analysis of animal posture, gait, and physical features. Accordingly, the imaging devices 1010 are communicatively coupled to the communications interface 1001 to transmit captured images to either the computer 1020 or the wireless transceiver 1040. In some embodiments, the imaging devices 1010 also interact with the trained artificial intelligence module 1126, which is configured to analyze the images for health indicators. In some embodiments, these devices are further adapted to function in low-light conditions through the use of infrared or night vision technologies.

When equipped with infrared sensing, an imaging device 1010 is configured to capture infrared images of livestock animals, providing a non-invasive method for monitoring their health and detecting potential issues. Such infrared images support infrared thermography, which enables the detection of heat/temperature measurements and variations across the animal's face and/or body. Heat/temperature variations can indicate muscle soreness, early-stage injuries, or inflammation. By capturing infrared images as the animal approaches and interacts with the health-monitoring feeder 1000, “hot spots” or areas of increased heat, relative to surrounding areas, that may signal underlying health concerns can be identified. Similarly, a facial (e.g., forehead) temperature reading may be captured from repeated infrared images that are taken from a consistent distance and/or angle with respect to the capturing camera 1010. These infrared images may be sent to a designated recipient, such as an owner, caretaker, trainer, or veterinarian. In some embodiments, the infrared images are analyzed by the artificial intelligence module 1126 to pinpoint specific areas of concern, allowing for targeted treatment plans and proactive health interventions, such as sending alerts to a designated entity, such as an owner, trainer, caretaker, and/or veterinarian. Additionally, the infrared imaging functionality can be used to monitor the healing process of injuries, offering horse owners, trainers, caretakers, and veterinarians valuable insights into recovery progress. This integration of infrared thermography into the feeder system 1000 enhances its capability to provide comprehensive health monitoring, further distinguishing it from conventional feeding solutions. Likewise, an average facial temperature average reading (e.g., a running average facial temperature and/or a rolling average facial temperature over a time window, such as a 14-day rolling window) can be compiled from infrared images captured of the face of a particular horse and then used as a baseline from which deviations in the facial temperature of the horse can be detected by the health-monitoring feeder 1000.

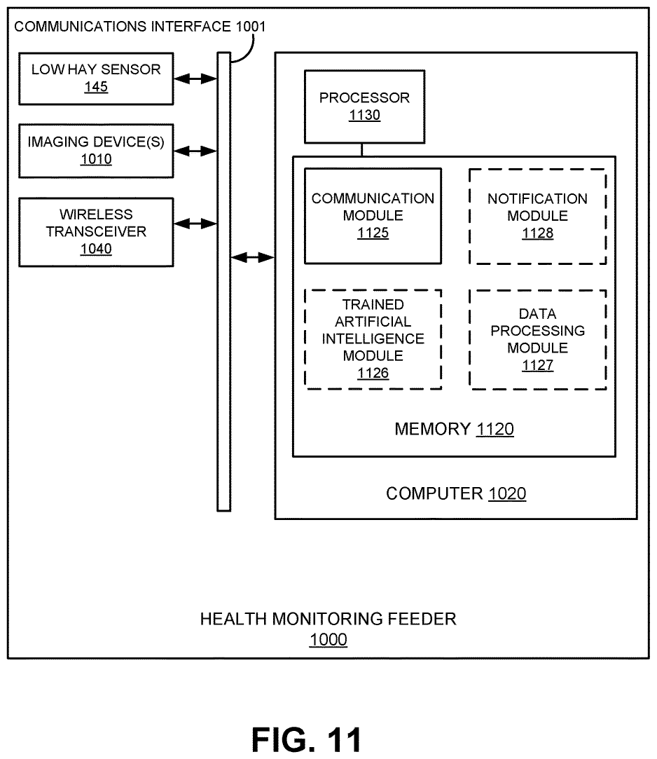

Computer 1020, when included, includes one or more processors and memory and may include applications, programs, or modules stored in the memory, which provide instructions that may be executed by the processor to perform one or more methods. For example, the memory may store one or more of a communication module 1125, a trained artificial intelligence module 1126, a data processing module 1127, and a notification module 1128 (all illustrated in FIG. 11).

Wireless transceiver 1040 (e.g., a Wi-Fi transceiver, cellular transceiver, and/or satellite transceiver (e.g., StarLink transceiver or the like)) operates to send data, alerts, processed data, and images, and to receive data and/or instructions.

A communications interface 1001 provides a bus, interconnect, or other means for wireline or wireless communicative coupling of the imaging devices 1010, wireless transceiver 1040, computer 1020, and/or low hay sensors 145, as required. In certain embodiments, the communications interface 1001 functions as the primary point for data exchange among the various components of the health-monitoring feeder 1000. As such, the communications interface 1001 establishes operational connections with the low hay sensor 145, imaging devices 1010, wireless transceiver 1040, and computer 1020 to support smooth communication. In some embodiments, the interface 1001 employs either wireline or wireless protocols to promote effective data transfer. As a result, the communications interface 1001 contributes significantly to facilitating coordinated system operation, ensuring that data collected by the sensors and imaging devices is processed and transmitted in an efficient manner.

With continued reference to FIG. 10, imaging devices 1010 provide their captured images to one or more of computer 1020 and wireless transceiver (e.g., a cellular transceiver in some embodiments), where the captured images may be analyzed locally in the computer 1020. The captured images are analyzed by an artificial intelligence module, which may be local or else sent to a remotely located trained artificial intelligence module. In some embodiments, imaging devices 1010 may take images at regular intervals, such as once per minute. In some embodiments, imaging devices 1010 may incorporate motion and/or proximity sensors to detect the approach and presence of a livestock animal, and thus trigger the capture of one or more images (such as at preset regular intervals) while the presence of a livestock animal is detected.

By including a date-time stamp in association with the capture of a captured moving or still image, feeding data may also be generated from the images. Some examples of feeding data include but are not limited to: time(s) of day that a livestock animal feeds, frequency of feeding of a livestock animal, total time per day that a livestock animal feeds, and average amount of time spent feeding in each feeding session by a livestock animal.

Imaging devices 1010-1 and 1010-2 are coupled with health-monitoring feeder 1000 in a manner that allows each to capture frontal views of a livestock animal, such as a horse, as the livestock animal approaches health-monitoring feeder 1000 and as the livestock animal interacts with health-monitoring feeder 1000 by slow-feeding on hay disposed within health-monitoring feeder 1000. Images captured by imaging devices 1010-1 and 1010-2 may be still or moving (e.g., video) images and capture frontal views of the livestock animal from the forelock down to the hoof as the livestock animal is approaching/walking up to health-monitoring feeder 1000 and interacting with/feeding from health-monitoring feeder 1000. Moving/video images may provide enhanced health monitoring over still images in some instances (e.g., for limping or gait issues). In images of a horse, for example, this includes imaging device 1010-1 and/or imaging device 1010-2 capturing frontal images of the teeth, chin, lips, nostrils, cheek, bars of the jaw, throat, neck, shoulder, point of the shoulder, chest, chestnut, forearms, knees, cannon, fetlock, pastern, and hooves, and further includes capturing still or moving images of the gait.

Imaging devices 1010-3 and 1010-4 are coupled with health-monitoring feeder 1000 in a manner that allows each to capture a side view of a livestock animal, such as a horse, as the livestock animal approaches health-monitoring feeder 1000 and as the livestock animal interacts with health-monitoring feeder 1000 by slow-feeding on hay disposed within health-monitoring feeder 1000. They are arranged on opposite sides of system 1000 and aimed inward, toward one another, such that both sides of an animal may be imaged. Images captured by imaging devices 1010-3 and 1010-4 may be still or moving (e.g., video) images and capture side views of the livestock animal from the forelock down to the hoof as the livestock animal is walking up to health-monitoring feeder 1000 and feeding from health-monitoring feeder 1000. In images of a horse, for example, this includes imaging device 1010-3 and/or 1010-4 capturing side images of the teeth, chin, lips, nostrils, cheek, bars of the jaw, throat, neck, shoulder, point of the shoulder, chest, chestnut, forearms, knees, cannon, fetlock, pastern, and hooves and further includes capturing still or moving images of the gait. The side view images may also capture images of the crest, wither, poll, elbow, barrel, loins, gaskin, hock, croup, point of rump back, point of hip, flank, hind chestnut, hind quarters, rear legs, and rear hooves of the livestock animal, in some embodiments. In the manner depicted, one or more imaging devices 1010 may be purposely positioned so that they will be configured to capture images of particular anatomical features, including, but not limited to: the facial area (forelock and/or jaw), chest, knees, and hooves.

System 1000 utilizes or provides information, such as captured images from imaging devices 1010, to a locally or remotely disposed artificial intelligence (AI) module for proactive livestock animal (e.g., equine, bovine, etc.) health monitoring. Using cellular connectivity, for example, and mounted imaging devices (e.g., cameras), system 1000 captures images of horses, for example, as they approach and feed, analyzing their gait, posture, and physical features for signs of health issues. Specific areas monitored include the facial area (forelock and/or jaw), chest, knees, and hooves, among others. System 1000 can identify or provide information used to identify ailments such as colic, laminitis, ulcers, respiratory issues, and gait abnormalities.

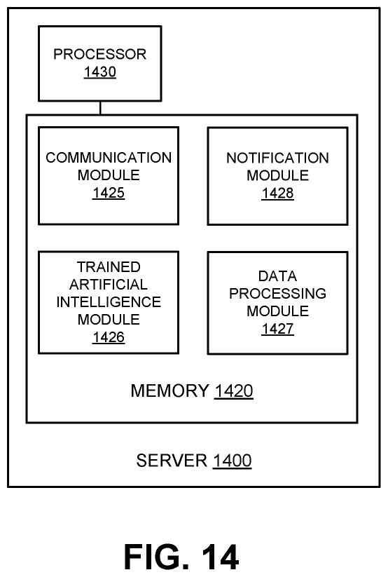

Images captured by imaging devices 1010 of system 1000 may be used for training a machine learning/AI system, sent to one or more designated persons for viewing/evaluation, and/or supplied to a real-time health monitoring artificial intelligence module. A data processing module 1125 included in computer 1020 or a data processing module 1425 in a remote server 1400 (both of FIG. 14) sends low-hay alerts, health alerts, and/or summaries via an “app” (e.g., an application installed on a user device such as a computer or an electronic device such as a tablet computer, smartphone, or wearable device like a smartwatch), text, email, and/or other designated means and may include sending of high-priority issues which include sending image-based notifications to veterinarians for further review/confirmatory diagnosis if a preliminary diagnosis of a health condition is made based on an AI analysis of the images. Additionally, system 1000 (via a data processing module 1125) provides daily feeding summaries for each horse, enhancing owner oversight and care. The daily feeding summaries are compiled information gleaned from image analysis such as: how many times a particular livestock animal has fed from system 1000, the total duration of time a particular livestock animal has fed from system 1000. In this manner, health monitoring is integrated with the slow-feeder's existing slow-feed functionality, offering a comprehensive solution for equine management.

FIG. 11 is a system-level block diagram of the electronic portions of health-monitoring feeder 1000, FIG. 10, in accordance with various embodiments. In some embodiments, the health-monitoring feeder 1000, as illustrated in FIG. 11, integrates a multiplicity of components to form a comprehensive system for slow feeding and proactive health monitoring of livestock animals. Feeder 1000 is designed not only to regulate access to hay but also to simultaneously capture data regarding feeding behavior and physical health. As depicted, the electronic portions of the system include: a plurality of imaging devices 1010 (e.g., 1010-1, 1010-2 . . . 1010-n), an optional computer system 1020, one or more low-feed sensors 145, and a wireless transceiver 1040. These components may be communicatively coupled with one another, as required, such as by a wireline communications interface 1001 (e.g., a bus), a wireless communications protocol (e.g., Bluetooth), or by other suitable means. When computer 1020 is not included, imaging device 1010 is communicatively coupled with wireless transceiver 1040 to send out captured images. Likewise, low-hay sensor 145 is communicatively coupled with wireless transceiver 1040 to send out low-hay alerts. Computer 1020, when included, comprises a memory 1120 which is communicatively coupled with one or more processors 1130.

Memory 1120 may include one or more modules which provide instructions that, when executed by processor 1130, cause processor 1130 to perform method procedures associated with the modules. In some embodiments, the memory 1120 includes one or more of: a communication module 1125, a trained artificial intelligence module 1126, a data processing module 1127, and a notification module 1128.

Communication module 1125 is configured to transmit the captured images, health alerts, feeding summaries, and/or low-hay alerts via wireless transceiver 1040 to one or more of a designated user device (e.g., a cellphone via texting to a phone number associated with the cellphone), a designated application (e.g., an application that a user may install on a user device such as a computer or another electronic device such as a smartphone), and a remote server.

Trained artificial intelligence module 1126, when included, is pre-trained on images of healthy and unhealthy livestock animals (with known diseases/health conditions) so that it is configured to analyze the captured images to detect health indicators of the livestock animals, including from posture, gait, and distinct physical features of the livestock animals that are visible in the captured images. That is, the trained AI module 1126 is pre-trained using a dataset comprising annotated livestock images, thereby enabling the identification of conditions including colic, laminitis, ulcers, and respiratory issues, among others. In some embodiments, trained artificial intelligence module 1126 is also continually trained to analyze additional information of a particular animal (e.g., horse 1201), which may also be discerned from captured images, such as information about animal facial temperature and/or about feeding habits, such as feeding frequency and/or amount of time per feeding session. Some examples of health conditions that trained AI module 1126 is trained to detect in the captured images include, but are not limited to: colic, impaction colic, sand colic, fever, pigeon fever, hot spots, laminitis, ulcers, insulin resistance, respiratory issues, and a need for teeth floating. Trained artificial intelligence module 1126 is configured in this manner to analyze the images for a variety of health indicators. In some embodiments, the trained artificial intelligence module 1126 interacts with the data processing module 1127 to generate health alerts and feeding summaries based on the analysis performed by the artificial intelligence module 1126.

Data processing module 1127, when included, is configured to generate health alerts based on the analysis of the images performed by the artificial intelligence module 1126 and to also compile feeding summaries based on the analysis of the images. Accordingly, the data processing module 1127 processes information related to feeding behavior, such as frequency and duration, and integrates such data with relevant health indicators to furnish comprehensive reports. In some embodiments, the data processing module 1127 interacts with the notification module 1128 to ensure that alerts and summaries are promptly delivered to designated user devices.

Notification module 1128, when included, is configured to send the health alerts, one or more images of the captured images, and the feeding summaries to one or more of a designated application (which is accessible by a user) and a designated user device. In some embodiments, the notification module 1128 is configured to generate and send alerts based on data processed by the computer 1020. Accordingly, such alerts may include health warnings, low hay notifications, and comprehensive feeding summaries. In some embodiments, the notification module 1128 interacts with the communication module 1125 to transmit alerts to designated applications or devices. As a result, the module may also be configured to send high-priority alerts, including images, directly to veterinarians for the confirmatory diagnosis of health conditions.

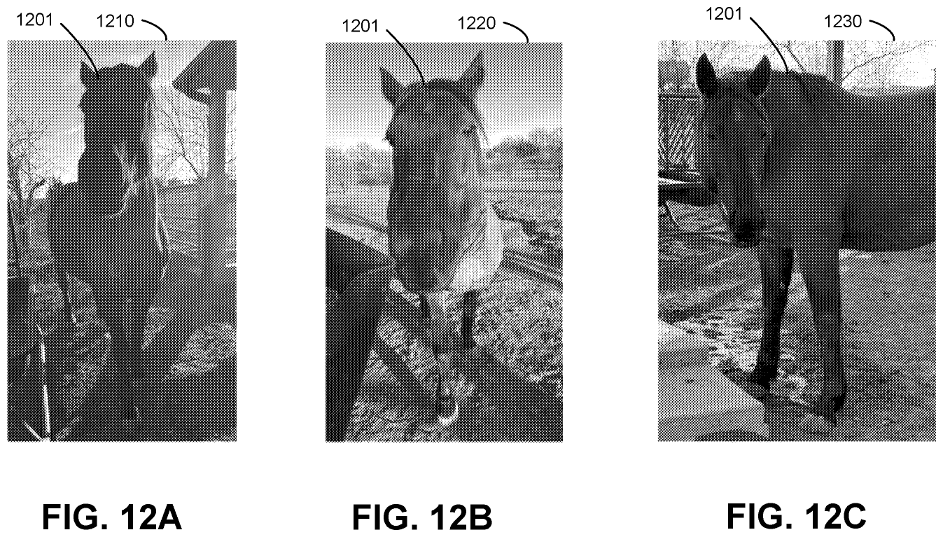

FIGS. 12A-12C illustrate some examples of images of a livestock animal 1201 (a horse in this example) that are captured by imaging devices 1010 of the health-monitoring feeder 1000 with proactive health monitoring of FIG. 10, in accordance with various embodiments. FIG. 12A shows a first frontal image 1210 of a first horse 1201, which was captured, for example, by imaging device 1010-2. FIG. 12B shows a second frontal image 1220 of the first horse 1201, which has been captured, for example, by imaging device 1010-1. FIG. 12C shows a side image 1230 of the first horse 1201, which has been captured, for example, by imaging device 1010-3.

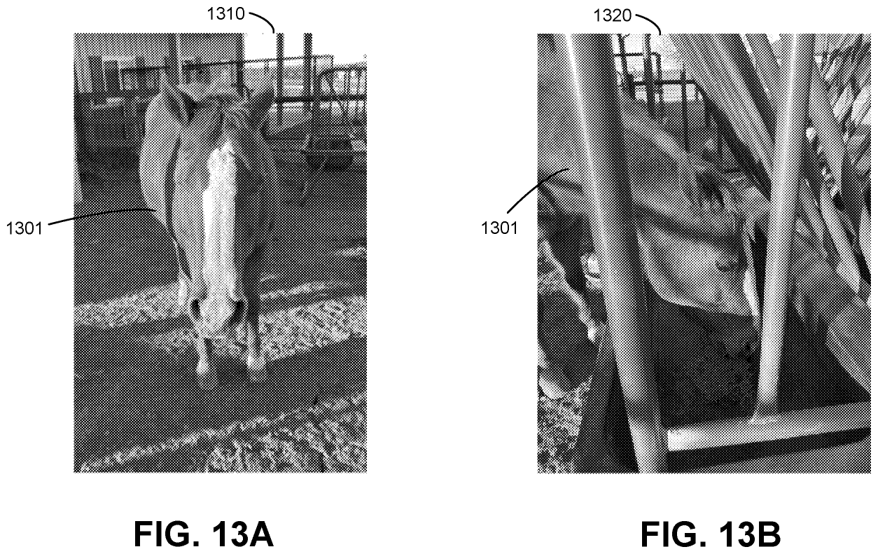

FIGS. 13A-13B illustrate some examples of images of a second livestock animal 1301 (a second horse in this example) that are captured by imaging devices 1010 of the health-monitoring feeder 1000 with proactive health monitoring of FIG. 10, in accordance with various embodiments. FIG. 13A shows a frontal image 1310 of the second horse 1301, which was captured, for example, by imaging device 1010-1. FIG. 13B shows a side image 1320 of the second horse 1301, which has been captured, for example, by imaging device 1010-4.

In some embodiments, a trained AI module 1126/1426 is configured to differentiate between images of different livestock animals and thus identifies images 12A-12C as being of a first horse and identifies images 13A-13B as being of a second horse that is different from the first horse. For example, the trained artificial intelligence module 1126/1426 may be provided with multiple images of a livestock animal (such as horse 1201) so that it may be trained to recognize the animal via machine learning or artificial intelligence image recognition techniques. This can be accomplished for multiple different livestock animals (e.g., for horse 1201, horse 1202, etc.). As captured images may be of multiple livestock animals (e.g., different individual livestock animals in different captured images or multiple livestock animals in a single captured image), the artificial intelligence module 1126/1426 is thus configured to recognize/identify the livestock animal(s) in the captured images and then associate the data derived from the captured images with individual animals, of the multiple livestock animals. For example, when horse 1201 is identified in a captured image or a portion of a captured image, hotspots, facial temperature data, feeding data, etc. identified by artificial intelligence module 1126/1426 are attributed to horse 1201; likewise with data derived for a captured image or portion of a captured image in which horse 1301 is identified. In this manner, images can be captured of multiple livestock animals and the artificial intelligence module 1126/1426 is configured to associate the data derived from the captured images with individual animals, of the multiple livestock animals, which are identified.

FIG. 14 illustrates an example of a remote server 1400, which may receive captured images and other data from a health-monitoring feeder 1000 for remote analysis, in various embodiments. The remote server includes a processor 1430 for processing images and/or data according to instructions stored in memory 1420.

Memory 1420 may include one or more modules that provide instructions that, when executed by processor 1430, cause processor 1430 to perform method procedures associated with the modules. In some embodiments, the memory 1420 includes one or more of: a communication module 1425, a trained artificial intelligence module 1426, a data processing module 1427, and a notification module 1428.

Communication module 1425 functions in the same manner as communication module 1125 and is configured to receive captured images and other information transmitted from health-monitoring feeder 1000. Communication module 1425 is also configured to transmit the captured images, health alerts, feeding summaries, and/or low hay alerts via wireless means to one or more of a designated user device (e.g., a cellphone via texting to a phone number associated with the cellphone) and a designated application (e.g., an application that a user may install on a computer or an electronic device such as a smartphone).

Trained artificial intelligence module 1426 functions in the same manner as trained AI module 1126 and is pre-trained on images of healthy and unhealthy livestock animals (with known diseases/health conditions) so that it is configured to analyze the captured images to detect health indicators of the livestock animals, including from posture, gait, and distinct physical features of the livestock animals that are visible in the captured images. That is, the trained AI module 1426 is pre-trained using a dataset comprising annotated livestock images, thereby enabling the identification of conditions including colic, laminitis, ulcers, and respiratory issues, among others. In some embodiments, trained artificial intelligence module 1426 is also continually trained to analyze additional information of a particular animal (e.g., horse 1201), which may also be discerned from captured images, such as information about animal facial temperature and/or about feeding habits, such as feeding frequency and/or amount of time per feeding session. Some examples of health conditions that trained AI module 1426 is trained to detect in the captured images include, but are not limited to: colic, impaction colic, sand colic, fever, pigeon fever, hot spots, laminitis, ulcers, insulin resistance, respiratory issues, and a need for teeth floating. Trained artificial intelligence module 1426 is configured in this manner to analyze the images for a variety of health indicators. In some embodiments, the trained artificial intelligence module 1426 interacts with the data processing module 1427 to generate health alerts and feeding summaries based on the analysis performed by the artificial intelligence module.

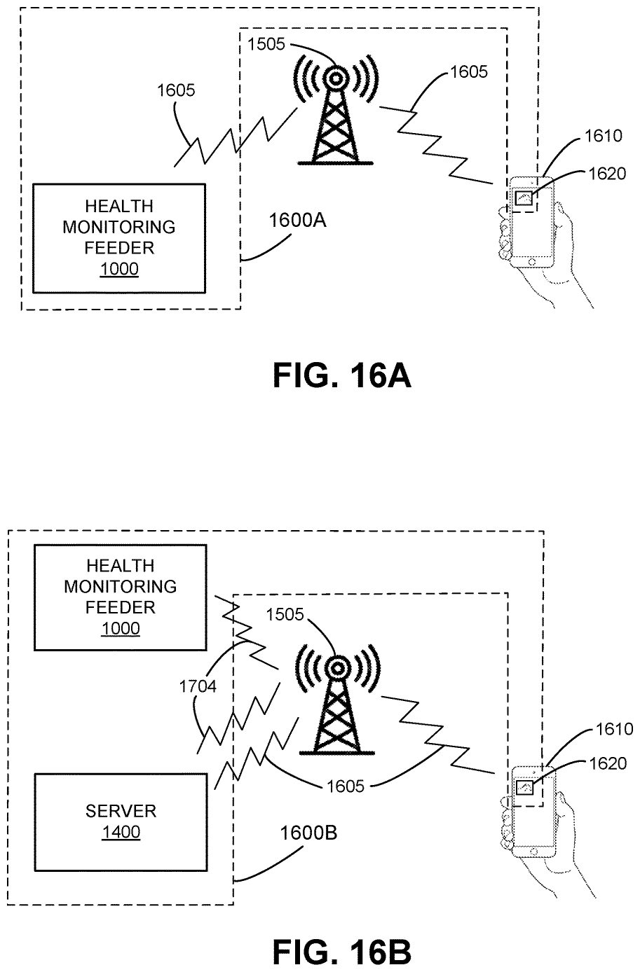

The health-monitoring feeder 1000 and/or server 1400 may utilize image recognition techniques to differentiate between multiple horses, such as horse 1201 and horse 1301, that appear in images captured by one or more imaging devices 1010. This can be achieved by training a machine learning model encompassed in a trained artificial intelligence module (1126, 1426, or the like) on a dataset of images of each individual horse, allowing the model to learn unique features and characteristics of each horse. The trained model can then be applied to newly captured images to identify which horse is present in the image. This capability enables the health-monitoring feeder 1000 to associate feeding data and health alerts with the correct individual horse (e.g., horse 1201, 1301, etc.), providing more accurate and personalized monitoring and care. By leveraging image recognition, a health-monitoring feeder 1000 and/or a proactive health monitoring system (e.g., system 1600A of FIGS. 16A, 1600B of FIG. 16B) can automatically differentiate between horses and generate horse-specific alerts and summaries, enhancing the overall effectiveness of health monitoring.

Data processing module 1427 functions in the same manner as data processing module 1127 and is configured to generate health alerts based on the analysis of the images performed by the artificial intelligence module 1426 and to also compile feeding summaries based on the analysis of the images. Accordingly, the data processing module 1427 processes information related to feeding behavior, such as frequency and duration, and integrates such data with relevant health indicators to furnish comprehensive reports. In some embodiments, the data processing module 1427 interacts with the notification module 1428 to ensure that alerts and summaries are promptly delivered to designated user devices.

Notification module 1428 functions in the same manner as notification module 1128 and is configured to send the health alerts, one or more images of the captured images, and the feeding summaries to one or more of a designated application and a designated user device. In some embodiments, the notification module 1428 is configured to generate and send alerts based on data processed by the server computer 1400. Accordingly, such alerts may include health warnings, low hay notifications, and comprehensive feeding summaries. In some embodiments, the notification module 1428 interacts with the communication module 1425 to transmit alerts to one or more designated applications (accessible by a user) and/or to one or more devices designated by a user. As a result, the notification module 1428 may also be configured to send high-priority alerts, including images, directly to veterinarians for the confirmatory diagnosis of health conditions.

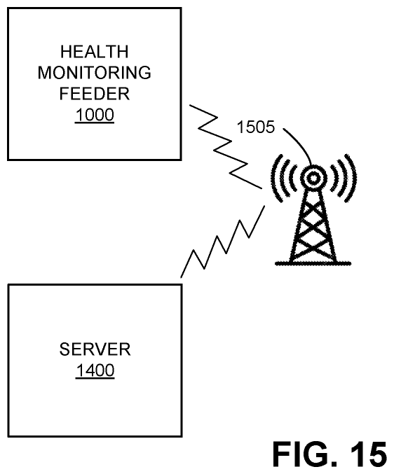

FIG. 15 is a schematic block diagram that, according to various embodiments, illustrates the integration of the health-monitoring feeder 1000 with a remote server 1400 for data processing and health analysis.

For example, FIG. 15 illustrates an example of the transmission, for remote analysis, of captured images of a livestock animal(s) and/or other data from health-monitoring feeder 1000 of FIG. 10 to remote server 1400, in accordance with various embodiments. Server 1400 is located remotely from the health-monitoring feeder (e.g., 100 feet away, or many miles away), receives the transmitted images, and performs the remote analysis of the images. In the illustrated example, a cellular network 1505 is utilized for the wireless communication, but other wired and wireless networks/protocols and combinations thereof may be similarly utilized.

FIG. 16A is a schematic system diagram of a proactive livestock animal health monitoring system 1600A that illustrates the transmission of information 1605, such as one or more of health alerts, captured images, and feeding summaries from the health-monitoring feeder to a mobile device via a wireless communications network 1505, in accordance with various embodiments. System 1600A includes a health-monitoring feeder 1000 and may include an application 1620 that is accessible by a user device, such as device 1610. The user device 1610 may be communicatively coupled with system 1600A but is not typically part of system 1600A.

FIG. 16A illustrates an example of the wireless transmission of information 1605, such as health alerts, one or more images of the captured images of a livestock animal, and a feeding summary for a livestock animal, wirelessly from computer 1020 of health-monitoring feeder 1000 to an application 1620 on or accessed (such as on a webpage) by a designated device 1610, in accordance with various embodiments. A low hay alert may be sent from health-monitoring feeder 1000 to designated device 1610 or designated application 1620 in the same manner. Likewise, an animal temperature alert or a hotspot alert may be sent from server 1400 to designated device 1610 or designated application 1620 in the same manner. In the illustrated example, a cellular network 1505 is utilized for the wireless communication, but other wired and wireless networks/protocols and combinations thereof may be similarly utilized.

FIG. 16B is a schematic system diagram of a proactive livestock animal health monitoring system 1600B, which illustrates the transmission of information 1704, such as captured images and other data, from health-monitoring feeder 1000 to remote server 1400 for analysis and processing, and the additional transmission of information 1605, such as health alerts, captured images, and feeding summaries, from remote server 1400 to a designated mobile device 1610 or application 1620 via a wireless communications network 1505, in accordance with various embodiments. System 1600B includes a health-monitoring feeder 1000, a server 1400, and may include an application 1620, which is accessible by a user device, such as device 1610. The user device 1610 may be communicatively coupled with system 1600B but is not typically part of system 1600B.

For example, following processing of information 1704, such as captured images sent from health-monitoring feeder 1000 to server 1400, FIG. 16B illustrates an example of the transmission of information 1605, wirelessly from server 1400 to a designated device 1610 or designated application 1620. The information 1605 may include one or more of health alerts, images of the captured images of a livestock animal, and a feeding summary for a livestock animal. A low hay alert may be sent from server 1400 to designated device 1610 or designated application 1620 in the same manner. Likewise, an animal temperature alert or a hotspot alert may be sent from server 1400 to designated device 1610 or designated application 1620 in the same manner. In the illustrated example, a cellular network 1505 is utilized for the wireless communication, but other wired and wireless networks/protocols and combinations thereof may be similarly utilized.

### EXAMPLE METHODS OF OPERATION

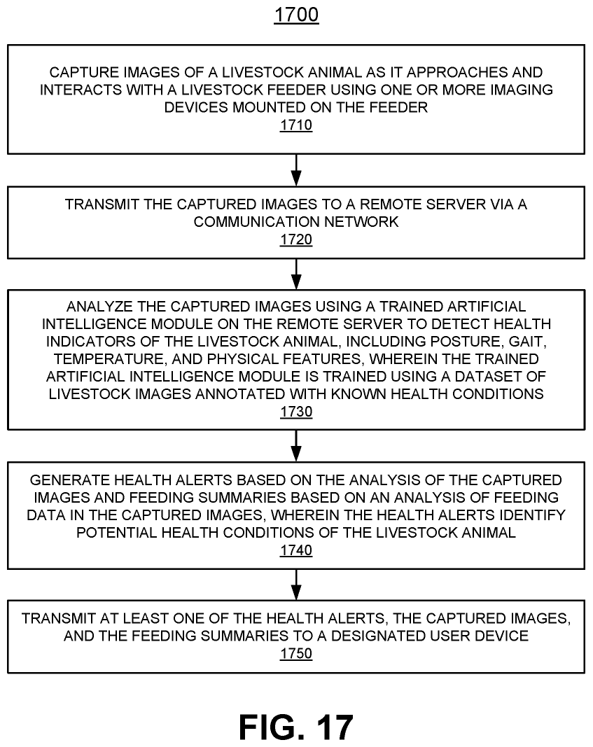

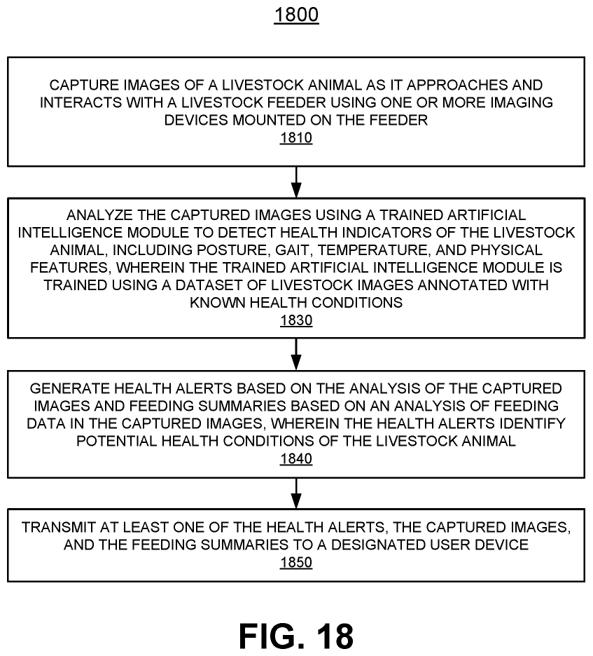

The following discussion sets forth in detail the operation of some example non-limiting methods of operation. With reference to FIGS. 17 and 18, flow diagrams 1700 and 1800 illustrate example procedures. Flow diagrams 1700 and 1800 include some procedures that are carried out by a processor under the control of computer-readable and computer-executable instructions. In this fashion, procedures described herein and in conjunction with flow diagrams 1700 and/or 1800 are, or may be, implemented using one or more computers and/or processors, in various embodiments. The computer-readable and computer-executable instructions can reside in any tangible computer-readable storage media. Some non-limiting examples of tangible computer-readable storage media include random access memory, read-only memory, magnetic disks, and optical disks. The computer-readable and computer-executable instructions, which reside on tangible computer-readable storage media, are used to control or operate in conjunction with, for example, one or some combination of processors of a distributed computing system. It is appreciated that the processor(s) may be physical or virtual, or some combination (it should also be appreciated that a virtual processor is implemented on physical hardware). Although specific procedures are disclosed in flow diagrams 1700 and 1800, such procedures are examples. That is, embodiments are well suited to performing various other procedures or variations of the procedures recited in flow diagram 1700 and/or 1800. Likewise, in some embodiments, the procedures in flow diagrams 1700 and/or 1800 may be performed in an order different than presented, and/or not all of the procedures described in one or more of these flow diagrams may be performed. It is further appreciated that procedures described in flow diagram 1700 and/or 1800 may be implemented in hardware, or a combination of hardware and firmware, or a combination of hardware and software.

FIG. 17 illustrates a flow diagram 1700 of a method of proactively monitoring the health of livestock animals, in accordance with various embodiments.

The method begins at 1710, where images of livestock animals are captured as they approach and interact with a livestock feeder equipped with imaging devices 1010. The feeder 1000, in some embodiments, includes a feed-through grid panel 120 configured to regulate access to baled hay that is disposed within the feeder 1000. In other embodiments, a generic feeder, which does not include a feed-through grid panel 120, but is equipped with one or more imaging devices 1010, may be utilized. The captured images (see FIGS. 12 and 13 for some examples of captured images) provide data on the physical features and behavior of the livestock animals. In some embodiments, the imaging devices 1010 capture specific anatomical features of the livestock animals, including the facial area (forelock and/or jaw), chest, knees, and hooves. This may involve the imaging devices 1010 focusing their lenses on these regions of a livestock animal so as to specifically capture these anatomical features and/or being positioned such that these features are captured by the images. These anatomical features are monitored to detect physical indicators of health, such as abnormalities in posture, gait, temperature, or physical appearance. The captured data is also integrated into the overall health monitoring process, enabling the artificial intelligence module to perform a comprehensive analysis of the livestock animals'health and feeding behavior. This aspect ensures that the system provides detailed and actionable insights into the well-being of the livestock animals, enhancing the effectiveness of the proactive health monitoring system.

For example, one or more of the cameras 1010 may be configured to capture infrared images, which provide thermographic images for the animal that facilitate detection and measurement of heat/temperature levels and of hot spots on various physical locations on the animal. For example, a “hot spot” may show a joint or muscle that is at a relatively higher temperature than the surrounding portions of the animal. When this hot spot exceeds an independent threshold temperature and/or exceeds surrounding temperatures by a pre-established threshold (e.g., 1.5 degrees), then the artificial intelligence module 1426 may note this based on analyzing the captured images of an animal (e.g., horse 1201). The trained artificial intelligence module 1426 interacts with the data processing module 1427 to generate an appropriate health alert. Likewise, when a facial temperature for an identified horse, which is captured from one or more infrared images, exceeds a running average facial temperature of the horse and/or rolling average facial temperature of the horse by a threshold amount (e.g., 1.5 degrees over the course of a specified period of time, such as an hour), the trained artificial intelligence module 1426 interacts with the data processing module 1427 to generate an appropriate health alert that indicates the identified horse may be feverish. The data processing module 1427 interacts with the notification module 1428 to ensure that the generated health alert is promptly delivered to designated user devices, such as by being transmitted by the communication module 1425.

The captured images themselves, along with timestamps associated with the captured images, also provide, through analysis by the trained artificial intelligence module 1426 and/or the data processing module 1427, feeding data on the feeding habits of the livestock animals, to include: when a livestock animal feeds during the day, how frequently the livestock animal feeds during a day, the duration of each feeding session of a livestock animal, and the total duration of all feeding sessions of a livestock animal during a day. Additional information may be gleaned from images when multiple livestock animals feed from the same health-monitoring feeder 1000. Some examples of the additional information include: which of the animals feed at the same time as one another, and which of the animals feed separately from one another or from others of the livestock animals that share the feeder 1000. In some embodiments, the feeder 1000 may wirelessly communicate with wearable devices for livestock animals (e.g., electronic necklaces, ear tags, and the like) to acquire health data and/or health metrics, such as heart rate, activity levels, temperature, and the like, tracked by these wearable devices. In some embodiments, additional data may be transmitted along with the images, such as hay level information or low hay alerts, such that an amount/rate of hay consumption can be determined over time for an animal or animals feeding from the feeder 1000 by determining the intervals at which hay is required to be replenished in the feeder 1000.

At 1720, the captured images and feeding data are transmitted to a remote server (e.g., server 1400) via a communication network, such as a cellular or wireless network. The remote server receives the data for further processing. In some embodiments, where the feeder 1000 acquires health metrics from a wearable device worn by a livestock animal, these health metrics are also transmitted to the remote server for further processing. The metrics may include one or more of heart rate, activity level, temperature, and breathing rate for the animal wearing the wearable device. In some embodiments, the health data from the wearable device may be sent to the remote server independently of the feeder 1000 acquiring and sending the data (e.g., sent directly from the wearable device or by another intermediary other than the feeder 1000).

At 1730, the remote server analyzes the captured images using a trained artificial intelligence module (e.g., trained AI module 1426). The AI module 1426 is pre-trained on a dataset of annotated livestock images and is configured to identify individual livestock animals that appear in the captured images and to detect health indicators, including posture, gait, temperature, and physical features. That is, the images used for training are captured from similar camera angles as those captured by imaging devices 1010 and are annotated as being healthy or as having a particular disease/health condition. The AI analysis identifies potential health conditions, such as colic, laminitis, ulcers, respiratory issues, fever, and gait abnormalities, among others, based on the training of the AI. In some embodiments, the AI module 1426 may further be trained on normal feeding behaviors and/or abnormal feeding behaviors that are associated with particular diseases and/or health conditions for which health alerts may be generated. In such embodiments, the AI module 1426 may analyze feeding behavior patterns that are discernable from the captured images in order to detect abnormalities that are indicative of health issues for which health alerts may be generated. In some embodiments, the AI module 1426 may combine the feeding behavior patterns along with physical information that is discernable from the visual depiction of a livestock animal in the captured images in order to diagnose disease or health conditions for which health alerts may be generated. In some embodiments, when health metrics from a livestock animal's wearable device are available, this information (e.g., heart rate, activity level, temperature) may also be utilized/incorporated by AI module 1426 when diagnosing a disease/health condition. In some embodiments, the AI module 1426 may be additionally trained on the continual stream of images generated by feeder 1000, such that the training may be customized for the livestock animal or animals being monitored by and fed from feeder 1000. In this manner, AI module 1426 is trained to detect changes in health and/or feeding habits over time for an animal, which may be detected by comparison of currently captured images from feeder 1000 to previously captured images from feeder 1000 for the same animal(s).

In some embodiments, the artificial intelligence module 1426 is further configured to recommend dietary adjustments based on detected health conditions and feeding behavior. Some examples include recommendations to: supplement the hay with other food, supplement the hay with particular minerals, adjust the added weight to feed-through grid panel(s) 120 via weight-holder 123 to make it easier (less weight) or harder (more weight) for the livestock animals to extract hay, which is compressed by the overall weight of feed-through grid panels 120.

At 1740, health alerts are generated based on the analysis performed by the AI module 1426. Feeding summaries are also compiled based on the feeding data captured in the images. Feeding data may comprise information for an identified livestock animal, such as frequency and duration of eating food from the livestock feeder or being in proximity to the livestock feeder in a position where the livestock animal can access and eat the food (e.g., hay) in the feeder. The health alerts and feeding summaries may be generated by data processing module 1427, which formats data into a text message, email, a push notification to an application installed on a user-designated electronic device, or application-viewable graphic format for sending to a designated device, email account, or user-installed smartphone/computer application. The health alerts identify potential health conditions, while the feeding summaries provide insights into feeding behavior and consumption patterns. The feeding data may be compared to average feeding rates for the type of livestock animals or to historical feeding data from livestock animals in the captured images to determine a rate or average rate of consumption of hay disposed in feeder 1000. This consumption rate information may be included in the feeding summary and may be used to project both current and future hay consumption rates, which can together be used to predict when additional hay will need to be added to the feeder 1000 (i.e., it can project based on consumption rates when a low hay alarm may be generated so that there is a forewarning regarding the need to add hay to feeder 1000). Further, by calculating hay consumption rates and comparing these to established benchmarks for hay consumption for particular types and quantities of livestock animals feeding from a feeder 1000, data processing module 1427 can identify consumption rates that are below or above a benchmark consumption rate by a large enough amount (e.g., in excess of a threshold) such that potential health risks may be associated with one or more of the livestock animals utilizing the feeder 1000 (i.e., the animal(s) are consuming too much hay or too little hay for the type/number of animals that are utilizing feeder 1000). In some embodiments, hay consumption rates that are abnormal (too high/too low based on benchmarks) are provided as additional data to the AI module 1426 as further health diagnostic data. Likewise, by comparing actual feeding data to benchmark consumption rates, the trained artificial intelligence module 1426 and/or the data processing module 1427 may predict a consumption rate for food (e.g., a hay consumption rate) in the feeder and similarly estimate when the food will need to be replenished.

In some embodiments, artificial intelligence module 1426 is also configured to detect breeding intervals based on physical indicators captured in the images. For example, in some embodiments, artificial intelligence module 1426 is trained on images of female livestock animals that are in heat (ready for breeding) and not in heat (not ready for breeding) such that it can identify from physical characteristics and/or feeding behavior when a female livestock animal is ready or becoming ready for breeding. Intervals between breeding cycles for a particular livestock animal can, in this manner, be measured and tracked by artificial intelligence module 1426.

At 1750, at least one of the health alerts, the captured images, and the feeding summaries are transmitted, via a communication network, to a designated user device, account, or application (e.g., as a text message to a mobile phone, a message to an email account, or a message (e.g., a push notification) to a user-installed application on a computer or on an electronic device such as a smartphone, tablet computer, or wearable like an iWatch). Notification module 1428 may be utilized to effect this transmission via interaction with a transceiver of the server 1400. The user device/application displays the analyzed data, enabling owners, trainers, caretakers, veterinarians, or others to take timely action based on the health alerts and feeding summaries.

FIG. 18 illustrates a flow diagram 1800 of a method of proactively monitoring the health of livestock animals with a health-monitoring feeder, in accordance with various embodiments.

The method begins at 1810, where images of livestock animals are captured as they approach and interact with a livestock feeder equipped with imaging devices 1010. The feeder 1000, in some embodiments, includes a feed-through grid panel 120 configured to regulate access to baled hay that is disposed within the feeder 1000. In other embodiments, a generic feeder, which does not include a feed-through grid panel 120, but is equipped with one or more imaging devices 1010, may be utilized. The captured images (see FIGS. 12 and 13 for some examples of captured images) provide data on the physical features and behavior of the livestock animals. In some embodiments, the imaging devices 1010 capture specific anatomical features of the livestock animals, including the facial area (forelock and/or jaw), chest, knees, and hooves. This may involve the imaging devices 1010 focusing their lenses on these regions of a livestock animal so as to specifically capture these anatomical features and/or being positioned such that these features are captured by the images. These anatomical features are monitored to detect physical indicators of health, such as abnormalities in posture, gait, temperature, or physical appearance. The captured data is also integrated into the overall health monitoring process, enabling the artificial intelligence module to perform a comprehensive analysis of the livestock animals'health and feeding behavior. This aspect ensures that the system provides detailed and actionable insights into the well-being of the livestock animals, enhancing the effectiveness of the proactive health monitoring system.

For example, one or more of the cameras 1010 may be configured to capture infrared images, which provide thermographic images for the animal that facilitate detection and measurement of heat/temperature levels and of hot spots on various physical locations on the animal. For example, a “hot spot” may show a joint or muscle that is at a relatively higher temperature than the surrounding portions of the animal. When this hot spot exceeds an independent threshold temperature and/or exceeds surrounding temperatures by a pre-established threshold (e.g., 1.5 degrees), then the artificial intelligence module 1126 may note this based on analyzing the captured images of an animal (e.g., horse 1201). The trained artificial intelligence module 1126 interacts with the data processing module 1127 to generate an appropriate health alert. Likewise, when a facial temperature for an identified horse, which is captured from one or more infrared images, exceeds a running average facial temperature of the horse and/or rolling average facial temperature of the horse by a threshold amount (e.g., 1.5 degrees over the course of a specified period of time, such as an hour), the trained artificial intelligence module 1126 interacts with the data processing module 1127 to generate an appropriate health alert that indicates the identified horse may be feverish. The data processing module 1127 interacts with the notification module 1128 to ensure that the generated health alert is promptly delivered to designated user devices, such as by being transmitted by communication module 1125.

The captured images themselves, along with timestamps associated with the captured images, also provide, through analysis by the trained artificial intelligence module 1126 and/or data processing module 1127, feeding data on the feeding habits of the livestock animals, to include: when a livestock animal feeds during the day, how frequently the livestock animal feeds during a day, the duration of each feeding session of a livestock animal, and the total duration of all feeding sessions of a livestock animal during a day. Additional information may be gleaned from images when multiple livestock animals feed from the same health-monitoring feeder 1000. Some examples of the additional information include: which of the animals feed at the same time as one another, and which of the animals feed separately from one another or from others of the livestock animals that share the feeder 1000. In some embodiments, feeder 1000 may wirelessly communicate with wearable devices for livestock animals (e.g., electronic necklaces, ear tags, and the like) to acquire health data and/or health metrics, such as heart rate, activity levels, temperature, and the like, tracked by these wearable devices. In some embodiments, additional data may be transmitted along with the images, such as hay level information or low hay alerts, such that an amount/rate of hay consumption can be determined over time for an animal or animals feeding from the feeder 1000 by determining the intervals at which hay is required to be replenished in feeder 1000.

At 1830, the captured images are analyzed at the health-monitoring feeder 1000 using a trained artificial intelligence module (e.g., trained AI module 1126). The AI module 1126 is pre-trained on a dataset of annotated livestock images and is configured to identify individual livestock animals that appear in the captured images and to detect health indicators, including posture, gait, temperature, and physical features. That is, the images used for training are captured from similar camera angles as those captured by imaging devices 1010 and are annotated as being healthy or else having a particular disease/health condition. The AI analysis identifies potential health conditions such as colic, laminitis, ulcers, respiratory issues, fever, and gait abnormalities, among others, based on the training of the AI in the trained AI module 1126. In some embodiments, the AI module 1126 may further be trained on normal feeding behaviors and/or abnormal feeding behaviors that are associated with particular diseases and/or health conditions for which health alerts may be generated. In such embodiments, the AI module 1126 may analyze feeding behavior patterns that are discernable from the captured images in order to detect abnormalities that are indicative of health issues for which health alerts may be generated. In some embodiments, the AI module 1126 may combine the feeding behavior patterns along with physical information that is discernable from the visual depiction of a livestock animal in the captured images in order to diagnose disease or health conditions for which health alerts may be generated. In some embodiments, when health metrics from a livestock animal's wearable device are available, this information (e.g., heart rate, activity level, temperature) may also be utilized/incorporated by the AI module 1126 when diagnosing a disease/health condition. In some embodiments, the AI module 1126 may be additionally trained on the continual stream of images generated by the feeder 1000, such that the training may be customized for the livestock animal or animals being monitored by and fed from feeder 1000. In this manner, the AI module 1126 is trained to detect changes in health and/or feeding habits over time for an animal, which may be detected by comparison of currently captured images from feeder 1000 to previously captured images from feeder 1000 for the same animal(s).

In some embodiments, the artificial intelligence module 1126 is further configured to recommend dietary adjustments based on detected health conditions and feeding behavior. Some examples include recommendations to: supplement the hay with other food, supplement the hay with particular minerals, adjust the added weight to feed-through grid panel(s) 120 via weight-holder 123 to make it easier (less weight) or harder (more weight) for the livestock animals to extract hay, which is compressed by the overall weight of feed-through grid panels 120.

At 1840, health alerts may be generated based on the analysis performed by the AI module 1126. Feeding summaries may also be generated and/or compiled based on the feeding data captured in the images. The feeding summaries may be generated by one or more of trained AI module 1126 and data processing module 1127. Feeding data may comprise information for an identified livestock animal, such as frequency and duration of eating food from the livestock feeder or being in proximity to the livestock feeder in a position where the livestock animal can access and eat the food (e.g., hay) in the feeder. The health alerts and feeding summaries may be generated by data processing module 1127, which formats data into a text message, email, a push notification to an application installed on a user-designated electronic device, or application-viewable graphic format for sending to a designated device, email account, or user-installed smartphone/computer application. The health alerts identify potential health conditions, while the feeding summaries provide insights into feeding behavior and consumption patterns. The feeding data may be compared to average feeding rates for the type of livestock animals or to historical feeding data from livestock animals in the captured images to determine a rate or average rate of consumption of hay disposed in feeder 1000. This consumption rate information may be included in the feeding summary and may be used to project both current and future hay consumption rates, which can together be used to predict when additional hay will need to be added to the feeder 1000 (i.e., it can project based on consumption rates when a low hay alarm may be generated so that there is a forewarning regarding the need to add hay to feeder 1000). Further, by calculating hay consumption rates and comparing these to established benchmarks for hay consumption for particular types and quantities of livestock animals feeding from a feeder 1000, data processing module 1127 can identify consumption rates that are below or above a benchmark consumption rate by a large enough amount (e.g., in excess of a threshold) such that potential health risks may be associated with one or more of the livestock animals utilizing the feeder 1000 (i.e., the animal(s) are consuming too much hay or too little hay for the type/number of animals that are utilizing feeder 1000). In some embodiments, hay consumption rates that are abnormal (too high/too low based on benchmarks) are provided as additional data to the AI module 1126 as further health diagnostic data. Likewise, by comparing actual feeding data to benchmark consumption rates, the trained artificial intelligence module 1126 and/or the data processing module 1127 may predict a consumption rate for food (e.g., hay) in the feeder and similarly estimate when the food will need to be replenished.

In some embodiments, artificial intelligence module 1126 is also configured to detect breeding intervals based on physical indicators captured in the images. For example, in some embodiments, artificial intelligence module 1126 is trained on images of female livestock animals that are in heat (ready for breeding) and not in heat (not ready for breeding) such that it can identify from physical characteristics and/or feeding behavior when a female livestock animal is ready or becoming ready for breeding. Intervals between breeding cycles for a particular livestock animal can, in this manner, be measured and tracked by artificial intelligence module 1126.

At 1850, at least one of the health alerts, the captured images, and the feeding summaries are transmitted, via a communication network, to a designated user device 1610, account, or application 1620 (e.g., as a text message to a mobile phone, a message to an email account, or a message to a user-installed application on a computer or on an electronic device such as a smartphone, tablet computer, or wearable like an iWatch). See FIG. 16A for an example of transmission of information. Notification module 1128 may be utilized to effect this transmission via interaction with a transceiver 1040 of the health-monitoring feeder 1000. The user device/application displays the analyzed data, enabling owners, trainers, caretakers, veterinarians, or others to take timely action based on the health alerts and feeding summaries.

### Conclusion

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed:

1. A proactive health monitoring system for a livestock animal, comprising:
a livestock feeder comprising:
one or more imaging devices mounted on the livestock feeder and configured to capture images of the livestock animal as it approaches and interacts with the livestock feeder, wherein the captured images further comprise feeding data for the livestock animal; and
a communication module configured to transmit the captured images and feeding data to a remote server; and
the remote server comprising:
an artificial intelligence module trained to analyze the captured images to detect health indicators of the livestock animal, including at least one of posture, gait, temperature, and physical features;
a data processing module configured to analyze the captured images to generate health alerts and to compile feeding summaries based on the feeding data in the captured images; and
a notification module configured to send at least one of: the health alerts, the captured images, and the feeding summaries to one of a designated application and a designated device.

2. The proactive health monitoring system of claim 1, further comprising:
the designated application, wherein the designated application is configured to receive and display at least one of the captured images, the health alerts, and the feeding summaries.

3. The proactive health monitoring system of claim 1, wherein the imaging devices are positioned and configured to capture specific anatomical features of the livestock animal, including at least one of a facial area, a jaw, a chest, knees, and hooves.

4. The proactive health monitoring system of claim 1, wherein at least one imaging device of the imaging devices is configured to capture an infrared image to locate hotspots on an animal as it approaches to feed from the livestock feeder.

5. The proactive health monitoring system of claim 1, wherein the artificial intelligence module is trained to detect health conditions including colic, laminitis, ulcers, respiratory issues, and gait abnormalities.

6. The proactive health monitoring system of claim 1, wherein the system is configured to predict a hay consumption rate of hay disposed in the livestock feeder from the feeding data in the captured images.

7. The proactive health monitoring system of claim 1, wherein the artificial intelligence module is trained using a dataset of livestock images annotated with known health conditions.

8. The proactive health monitoring system of claim 1, wherein the imaging devices are configured to capture images of multiple livestock animals; and
the artificial intelligence module is configured to identify an individual animal from the captured images and associate the data derived from the captured images with the identified individual animal of multiple livestock animals.

9. The proactive health monitoring system of claim 1, wherein the artificial intelligence module is configured to:
identify a facial temperature of a horse and compare the temperature to one of a running average facial temperature for the horse and a rolling average for the horse to determine if the horse is feverish.

10. The proactive health monitoring system of claim 1, wherein the artificial intelligence module is configured to:
detect breeding intervals based on physical indicators of livestock animals identified in the captured images.

11. The proactive health monitoring system of claim 1, wherein the notification module is configured to:
send alerts via text message, email, or push notifications to the designated application.

12. A method of proactively monitoring health of a livestock animal, comprising:
capturing images of a livestock animal as it approaches and interacts with a livestock feeder using one or more imaging devices mounted on the livestock feeder,
transmitting the captured images to a remote server via a communication network;
analyzing the captured images using a trained artificial intelligence module on the remote server to detect health indicators of the livestock animal, including posture, gait, temperature, and physical features, wherein the trained artificial intelligence module is trained using a dataset of livestock images annotated with known health conditions;
generating a health alert based on an analysis of the captured images, wherein the health alert identifies potential health conditions of the livestock animal; and
transmitting the generated health alert to one of a designated user device and an application accessible by a user.

13. The method as recited in claim 12, wherein analyzing the captured images using a trained artificial intelligence module on the remote server comprises:
identifying a facial temperature of a horse from an infrared image of the captured images; and
comparing the facial temperature to one of a running average facial temperature for the horse and a rolling average facial temperature for the horse to determine if the horse is feverish.

14. The method as recited in claim 12, wherein the analyzing the captured images using a trained artificial intelligence module comprises:
identifying temperature measurements on one or more locations on the livestock animal from a captured infrared image; and
identifying a hot spot on the livestock animal from the temperature measurements.

15. The method as recited in claim 12, wherein the analyzing the captured images using a trained artificial intelligence module comprises:
detecting breeding intervals based on physical indicators of livestock animals identified in the captured images.

16. A livestock feeder comprising:
one or more imaging devices mounted on the livestock feeder and configured to capture images of a livestock animal as it approaches and interacts with the livestock feeder, wherein the captured images further comprise feeding data for the livestock animal;
an artificial intelligence module trained to analyze the captured images to detect health indicators of the livestock animal;
a data processing module configured to generate health alerts based on an analysis of the captured images and to compile feeding summaries based on the feeding data in the captured images; and
a notification module configured to send at least one of: the health alerts, the captured images, and the feeding summaries to one of a designated application and a designated device.

17. The livestock feeder of claim 16, further comprising:
a feed-through grid panel configured to regulate access to baled hay, wherein the feed-through grid panel is configured to press against baled hay contained in the livestock feeder in response to a weight of the feed-through grid panel, which is compressed against the baled hay by downhill rolling of the feed-through grid panel on a set of trolley tracks, which is continually affected by gravity as the baled hay is diminished by feeding of a livestock animal.

18. The livestock feeder of claim 16, wherein the artificial intelligence module is configured to:
identify a facial temperature of a horse from an infrared image of the captured images; and
compare the facial temperature to one of a running average facial temperature for the horse and a rolling average facial temperature for the horse to determine if the horse is feverish.

19. The livestock feeder of claim 16, wherein the artificial intelligence module is configured to:
identify temperature measurements on one or more locations on the livestock animal from a captured infrared image; and
identify a hot spot on the livestock animal from the temperature measurements.

20. The livestock feeder of claim 16, wherein the data processing module is configured to:
predict a hay consumption rate of hay disposed in the livestock feeder from the feeding data in the captured images.
